(19) United States
(12) Patent Application Publication
(10) Pub. No.: US 2024/0349227 A1
(43) Pub. Date: Oct. 17, 2024

(54) NODE IN A WIRELESS COMMUNICATION SYSTEM AND METHOD EXECUTED BY THE SAME

(71) Applicant: Samsung Electronics Co., Ltd., Suwon-si (KR)

(72) Inventors: Yunchuan YANG, Beijing (CN); Longhai ZHAO, Beijing (CN); Qi XIONG, Beijing (CN); He WANG, Beijing (CN)

(21) Appl. No.: 18/629,278

(22) Filed: Apr. 8, 2024

(30) Foreign Application Priority Data
Apr. 14, 2023 (CN) 202310403648.2
May 4, 2023 (CN) 202310492843.7
Jan. 9, 2024 (CN) 202410033850.5
Feb. 1, 2024 (CN) 202410146310.8

(51) Int. Cl. H04W 64/00; G01S 5/02; H04W 24/02

(52) U.S. Cl. CPC H04W 64/00; G01S 5/0273; H04W 24/02

(57) ABSTRACT

A node in a wireless communication system and a method performed by the same are provided. The method includes obtaining information related to a channel between a user equipment (UE) and a base station, and extracting first feature information based on the information related to the channel between the UE and the base station, the first feature information being used to determine information of a location of the UE using an artificial intelligence (AI) model and/or to monitor whether the AI model needs to be updated.

### CROSS-REFERENCE TO RELATED APPLICATION(S)

This application is based on and claims priority under 35 U.S.C. § 119 (a) of a Chinese patent application number 202310403648.2, filed on Apr. 14, 2023, in the Chinese Intellectual Property Office, of a Chinese patent application number 202310492843.7, filed on May 4, 2023, of a Chinese patent application number 202410033850.5, filed on Jan. 9, 2024, and of a Chinese patent application number 202410146310.8, filed on Feb. 1, 2024, in the Chinese Intellectual Property Office, the disclosure of each of which is incorporated by reference herein in its entirety.

### BACKGROUND

### 1. Field

The disclosure relates to a technical field of wireless communication. More particularly, the disclosure relates to a node in a wireless communication system and a method executed by the same.

### 2. Description of Related Art

In recent years, the artificial intelligence (AI) technology represented by deep learning algorithms has emerged once again to address issues that have existed for many years in various industries, and has achieved great technical and commercial success.

AI algorithms based on machine learning are also used to determine a location of a user equipment (UE) in a wireless communication. However, the complexity of existing AI models for positioning is high, and due to the mobility of the UE, the existing AI models for positioning could not properly reflect information of a current location of the UE, and the positioning accuracy needs to be further improved. Meanwhile, the amount of input data for the AI model is large and the feedback overhead is large. Therefore, there is an urgent need for a more optimal method and apparatus for determining the location of the UE.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by a UE and/or a base station and the UE and/or the base station that executes the method to at least address problems in the related art.

Additional aspects will be set forth in part in the description which follows and, in part, will be apparent from the description, or may be learned by practice of the presented embodiments.

In accordance with an aspect of the disclosure, a method performed by a first node in a wireless communication is provided. The method includes obtaining information related to a channel between a user equipment (UE) and a base station, extracting first feature information based on the information related to the channel between the UE and the base station, the first feature information being used to determine information of a location of the UE using an artificial intelligence (AI) model and/or to monitor whether the AI model needs to be updated.

Alternatively, the first feature information is related to energy and/or time of arrival of a multipath of the channel between the UE and the base station.

Alternatively, the first feature information includes at least one of feature information obtained by weighting the time of arrival of the multipath of the channel between the UE and the base station based on energy of the channel between the UE and the base station and feature information obtained by weighting the energy of the channel between the UE and the base station based on the time of arrival of the multipath of the channel between the UE and the base station.

Alternatively, the extracting of the first feature information based on the information related to the channel between the UE and the base station includes extracting the first feature information by using a signature transform based on the information related to the channel.

Alternatively, the extracting of the first feature information includes determining multi-dimensional continuous values corresponding to the information related to the channel, and extracting the first feature information based on the multi-dimensional continuous values.

Alternatively, the determining of the multi-dimensional continuous values corresponding to the information related to the channel includes transforming the information related to the channel into one-dimensional continuous values, and expanding the one-dimensional continuous values into the multi-dimensional continuous values.

Alternatively, the expanding of the one-dimensional continuous values into the multi-dimensional continuous values includes performing data augmentation on the one-dimensional continuous values corresponding to the information related to the channel over a predetermined domain to expand the one-dimensional continuous values into the multi-dimensional continuous values.

Alternatively, the performing of data augmentation on the one-dimensional continuous values corresponding to the information related to the channel over the predetermined domain includes performing the data augmentation on the one-dimensional continuous values corresponding to the information related to the channel over d1-1 predetermined domains to expand the one-dimensional continuous values into d1-dimensional values, wherein d1 is greater than or equal to 2.

Alternatively, the predetermined domain includes a time domain when the information related to the channel indicates an estimated value of channel impulse response (CIR), and/or the predetermined domain includes a frequency domain when the information related to the channel indicates an estimated value of channel frequency response (CFR).

Alternatively, when the information related to the channel indicates an estimated value of CIR, the information related to the channel includes N estimated values of CIR about the channel between the UE and the base station for Nmoments, the transforming of the information related to the channel between the UE and the base station into the one-dimensional continuous values includes transforming the N estimated values of CIR corresponding to the base station into N values corresponding to the N moments, and obtaining values corresponding to any moments between a first moment and an Nth moment based on the N values to obtain the one-dimensional continuous values from the first moment to the Nth moment.

Alternatively, the transforming of N estimated values of CIR corresponding to the base station into N values corresponding to the N moments includes performing normalization on the N estimated values of CIR corresponding to the base station, calculating a sum of squares of the real part and the imaginary part of each normalized CIR estimate value to obtain N sums of squares, and adding a first sum of squares to a kth sum of squares to obtain a value corresponding to a kth moment, wherein k is greater than or equal to 1 and less than or equal to N, the obtaining of the values corresponding to any moments between the first moment and the Nth moment based on the N values includes transforming the N values into the one-dimensional continuous values based on linear interpolation.

Alternatively, the extracting of the first feature information based on the multi-dimensional continuous values includes extracting the first feature information corresponding to the channel between the UE and a plurality of base stations based on the multi-dimensional continuous values corresponding to the information related to the channel between the UE and a plurality of base stations, or extracting the first feature information corresponding the channel between the UE and each of the plurality of base stations based on the multi-dimensional continuous values corresponding to the information related to the channel between the UE and each base station.

Alternatively, the first feature information corresponding to the channel between the UE and a plurality of base stations includes k2 level features, wherein the i2^{th}-level feature of the k2 level features is obtained by integrating i2 dimensions of information among the M*d1 dimensions of information over a time range from the first moment to the Nth moment, wherein k2 is greater than or equal to 1, i2 is greater than or equal to 1, and M is a number of the plurality of base stations, the first feature information corresponding to the channel between the UE and each base station includes k1 level features, wherein the i1^{th}-level feature of the k1 level features is obtained by integrating i1 dimensions of information among d1 dimensions of information over a time range from the first moment to the N^{th} moment, wherein k1 is greater than or equal to 1 and i1 is greater than or equal to 1.

Alternatively, the method further includes performing compression on the first feature information and taking the compressed features as the first feature information, or performing compression on the first feature information and selecting a part of the compressed features as the first feature information, or selecting a part of features in the first feature information as the first feature information.

Alternatively, the performing of compression on the first feature information includes performing logarithmic transformation on the first feature information to obtain the compressed features.

Alternatively, the selecting of the part of the compressed features as the first feature information, or the selecting of the part of the features in the first feature information as the first feature information, includes selecting the part of the compressed features as the first feature information, or selecting the part of features in the first feature information as the first feature information, based on at least one of a predefined criteria, configuration information configured by the base station or location management function (LMF), processing capability of the AI model, a type of the UE and/or a type of the base station, the information related to the channel, and the first feature information.

Alternatively, the information related to the channel includes at least one of a number of multipaths for CIR and time length for CIR values.

Alternatively, the method further includes at least one of determining the information of the location of the UE using a first AI model based on the first feature information, determining second feature information by using a second AI model based on the first feature information, and determining the information of the location of the UE based on the second feature information, transmitting the first feature information to a second node to facilitate the second node to determine the information of the location of the UE by using the first AI model based on the first feature information, or determine second feature information using a second AI model based on the first feature information and determine the information of the location of the UE based on the second feature information, determining second feature information by using a second AI model based on the first feature information, transmitting the second feature information to the second node to facilitate the second node to determine the information of the location of the UE based on the second feature information.

Alternatively, the determining of information of the location of the UE by using the first AI model based on the first feature information includes determining a communication environment between the UE and the base station based on the first feature information, and determining the information of the location of the UE using the first AI model based on the first feature information when the communication environment is a non-line-of-sight (NLOS) channel.

Alternatively, the transmitting of the first feature information to the second node further includes determining a communication environment between the UE and the base station based on the first feature information, reporting information related to the determined communication environment to the second node.

Alternatively, the determining of the information of the location of the UE by using the first AI model based on the first feature information includes receiving configuration information for determining the location of the UE from the second node, when it is determined that the location of the UE is to be determined by using the first AI model based on the configuration information for determining the location of the UE, determining the information of the location of the UE by using the first AI model based on the first feature information, wherein the first node is the UE, and the second node is a base station or an LMF.

Alternatively, the determining of the information of the location of the UE based on second feature information includes determining the information of the location of the UE by using a third AI model based on the second feature information.

Alternatively, the determining of the information of the location of the UE by using a third AI model based on the second feature information includes determining the information of the location of the UE by using the third AI model based on the second feature information, when a communication channel environment between the UE and the base station is a non-line-of-sight (NLOS) channel.

Alternatively, the method further comprises determining a communication environment between the UE and the base station based on the first feature information or the second feature information, the communication environment including a line-of-sight (LOS) communication and an NLOS communication.

Alternatively, the determining of the communication environment between the UE and the base station based on the second feature information includes determining the communication environment between the UE and the base station based on an LOS indicator or an NLOS indicator in the second feature information.

Alternatively, the second feature information indicates at least one of a reference signal time difference (RSTD), a round trip delay (RTT), an angle of arrival (AOA), a reference signal receiving power (RSRP), a line-of-sight (LOS) indicator and a non-line-of-sight (NLOS) indicator.

Alternatively, the method further includes at least one of calculating a monitoring metric based on the first feature information and determining whether the AI model needs to be updated based on a result of comparing the monitoring metric with a predetermined threshold, transmitting the first feature information to a second node to facilitate the second node to calculate a monitoring metric based on the first feature information and determine whether the AI model needs to be updated based on a result of comparing the monitoring criterion with a predetermined threshold, and calculating a monitoring metric based on the first feature information, transmitting the monitoring metric to a second node to facilitate the second node to determine whether the AI model needs to be updated based on a result of comparing the monitoring criterion with a predetermined threshold.

Alternatively, the first node is a user equipment (UE) and the second node is a base station or an LMF, or the first node is a base station and the second node is a UE or an LMF.

Alternatively, the calculating of the monitoring metric based on the first feature information includes calculating a norm value of the first feature information and using the norm value as the monitoring metric.

Alternatively, the first node is a UE, and the method further includes receiving configuration information indicative of updating of the AI model from the second node, and updating the AI model based on the configuration information.

Alternatively, the AI model is trained by training the AI model with first labeled data, inputting unlabeled data into the AI model to obtain second labeled data corresponding to the unlabeled data, selecting the second labeled data based on a confidence level, and training the AI model trained based on the first labeled data and the selected second labeled data.

Alternatively, the information related to the channel includes at least one of an uplink signal, a downlink signal, an estimated value of channel impulse response (CIR), and an estimated value of channel frequency response (CFR).

In accordance with another aspect of the disclosure, a method performed by a second node in a wireless communication system is provided. The method includes receiving first feature information or second feature information transmitted by a first node, when the first feature information is received, performing at least one of determining information of a location of a UE by using a first AI model based on the first feature information, determining second feature information by using a second AI model based on the first feature information and determining the information of the location of the UE based on the second feature information, when the second feature information is received, determining the information of the location of the UE based on the received second feature information, wherein the received first feature information is extracted based on information related to a channel between the UE and a base station by the first node, and/or the received second feature information is determined based on the extracted first feature information using a second AI model by the first node.

Alternatively, the first node is a UE and the second node is a base station or an LMF, or the first node is a base station and the second node is a UE or an LMF.

Alternatively, the determining of the information of the location of the UE by using the first AI model based on the first feature information includes determining a communication environment between the UE and the base station based on the first feature information, and determining the information of the location of the UE by using the first AI model based on the first feature information when the communication environment is a non-line-of-sight (NLOS) communication.

Alternatively, the method further includes receiving information related to a communication environment transmitted by the first node, the information related to the communication environment being sent after determining the communication environment between the UE and the base station based on the first feature information by the first node.

Alternatively, the determining of the information of the location of the UE based on the second feature information includes determining the information of the location of the UE by using a third AI model based on the second feature information.

Alternatively, the determining of the information of the location of the UE by using the third AI model based on the second feature information includes determining the information of the location of the UE by using the third AI model based on the second feature information when a communication channel environment between the UE and the base station is a non-line-of-sight (NLOS) channel environment

Alternatively, the method further includes determining a communication environment between the UE and the base station based on the first feature information or the second feature information, the communication environment including a line-of-sight (LOS) channel environment and an NLOS channel environment.

Alternatively, the determining of the communication environment between the UE and the base station based on the second feature information includes determining the communication environment between the UE and the base station based on an LOS indicator or a NLOS indicator in the second feature information.

Alternatively, the second feature information indicates at least one of a reference signal time difference (RSTD), a round trip delay (RTT), an angle of arrival (AOA), a reference signal receiving power (RSRP), a line-of-sight (LOS) indicator and a non-line-of-sight (NLOS) indicator.

In accordance with another aspect of the disclosure, a method performed by a second node in a wireless communication system is provided. The method includes receiving first feature information or a monitoring metric transmitted by a first node, when the first feature information is received, calculating a monitoring metric based on the first feature information, and determining whether an AI model corresponding to determining a location of a UE needs to be updated based on a result of comparing the monitoring metric with a predetermined threshold, when the monitoring metric is received, determining whether the AI model needs to be updated based on a result of comparing the monitoring metric with the predetermined threshold value, wherein the received first feature information is extracted based on information related to a channel between the UE and a base station by the first node, and/or the received monitoring metric is calculated based on the extracted first feature information by the first node.

Alternatively, the first node is a UE and the second node is a base station or an LMF, or the first node is a base station and the second node is a UE or an LMF.

Alternatively, the calculating of the monitoring metric based on the first feature information includes calculating a norm value of the first feature information and using the norm value as the monitoring metric.

In accordance with another aspect of the disclosure, a node in a wireless communication system is provided. The node includes memory storing one or more computer programs, one or more processors communicatively coupled to the memory, wherein the one or more computer programs include computer-executable instructions that, when executed by the one or more processors, cause the node to obtain information related to a channel between a UE and a base station and extract first feature information based on the information related to the channel between the UE and the base station, the first feature information being used to determine information of a location of the UE using an AI model and/or to monitor whether the AI model needs to be updated.

In accordance with another aspect of the disclosure, one or more non-transitory computer readable storage media storing computer-executable instructions that, when executed by one or more processors of a node in a wireless communication system, cause the node to perform operations are provided. The operations include obtaining information related to a channel between a UE and a base station and extracting first feature information based on the information related to the channel between the UE and the base station, the first feature information being used to determine information of a location of the UE using an AI model and/or to monitor whether the AI model needs to be updated.

In accordance with another aspect of the disclosure, a computer program product comprising a computer program, wherein the computer program, when executed by a processor, implements the method is provided.

The embodiments of the disclosure provide a node in a wireless communication system and a method performed by the same bring at least the following beneficial effects the accuracy of localization for the UE is improved and/or the complexity of the AI model for determining the location of the UE is reduced.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIGS. 2A and 2B illustrate a wireless transmission path and an example wireless reception path according to various embodiments of the disclosure;

FIG. 3A illustrates a user equipment (UE) according to an embodiment of the disclosure;

FIG. 3B illustrates a base station according to an embodiment of the disclosure;

FIG. 4 is a flowchart illustrating a method for determining a location of a UE according to an embodiment of the disclosure;

FIG. 5 illustrates geometric meaning of some signature transform features according to an embodiment of the disclosure;

FIG. 6 illustrates a schematic diagram of a process for predicting a location of a UE based on a channel impulse response (CIR) estimate value, according to an embodiment of the disclosure;

FIG. 7 illustrates a flowchart of a method in which a UE executes extracting of first feature information and location management function (LMF) determines a location of the UE, according to an embodiment of the disclosure;

FIG. 8 illustrates a flowchart of a method in which a UE executes extracting of feature information and the UE determines a location of the UE according to an embodiment of the disclosure;

FIG. 9 illustrates a flowchart of a method in which a UE executes extracting of feature information and the UE determines a location of the UE according to an embodiment of the disclosure;

FIG. 10 illustrates a flowchart of a method in which a base station executes extracting of feature information and an LMF determines a location of a UE according to an embodiment of the disclosure;

FIG. 11 illustrates a flowchart of a method in which a base station executes extracting of weighted time-energy feature information and an LMF determines a location of a UE according to an embodiment of the disclosure;

FIG. 12 illustrates a flowchart of a method in which a base station executes extracting of feature information and a UE determines a location of the UE according to an embodiment of the disclosure;

FIG. 13 illustrates a flowchart of a method in which a UE executes extracting of feature information and an LMF executes calculating of a model supervisory criteria according to an embodiment of the disclosure;

FIGS. 14A and 14B illustrate a schematic diagram of a method of determining a location of a UE using an artificial intelligence (AI) model and supervising the AI model, according to an embodiment of the disclosure;

FIG. 15 illustrates a schematic diagram of a method for determining a location of a UE according to an embodiment of the disclosure;

FIG. 16 illustrates a schematic diagram of a structure of an electronic apparatus suitable for according to an embodiment of the disclosure; and

FIGS. 17 and 18 illustrate schematic diagrams of downscaling using the principal component analysis and the Siamese network according to various embodiments of the disclosure.

Throughout the drawings, it should be noted that like reference numbers are used to depict the same or similar elements, features, and structures.

### DETAILED DESCRIPTION OF THE EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of the various embodiments of the disclosure is provided for illustration purpose only and not for the purpose of limiting the disclosure as defined by the appended claims and their equivalents.

It should be understood that the singular forms “a”, “an” and “the” include plural reference, unless the context clearly indicates otherwise. Thus, for example, reference to “a component surface” includes reference to one or more of such surfaces.

When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the disclosure, and does not limit the presence of one or more additional functions, operations, or features. In addition, the terms “include” or “have” may be interpreted to denote certain features, figures, steps, operations, constituent elements, components, or combinations thereof, but should not be interpreted to exclude the possibility of the presence of one or more other features, figures, steps, operations, constituent elements, components, or combinations thereof.

The term “or” as used in the various embodiments of the disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3.

All terms (including technical or scientific terms) used in the disclosure have the same meaning as understood by those skilled in the art to which the disclosure belongs, unless defined differently. Common terms as defined in dictionaries are interpreted to have a meaning consistent with the context in the relevant technology art and should not be interpreted in an idealized or overly formalistic manner, unless expressly so defined in the disclosure.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. At this time, the one or more processors may be a general purpose processor, such as a central processing unit (CPU), an application processor (AP), or the like, or may be a graphics-only processing unit, such as a graphics processing unit (GPU), a visual processing unit (VPU), and/or an AI-dedicated processor, such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning algorithm to a plurality of learning data, a predefined operating rule or an AI model of a desired characteristic is made. The learning may be performed in a device or electronic apparatus itself in which AI according to an embodiment is performed, and/or may be implemented through a separate server/system.

The AI model may consist of a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

The learning algorithm is a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

According to the disclosure, at least one step of the method performed in an electronic apparatus, may be implemented using an artificial intelligence model. Processors of the electronic apparatus may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm.

The technical solutions of the embodiments of the disclosure may be applied to various communication systems, for example, a global system for mobile communications (GSM) system, a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD), a universal mobile telecommunication system (UMTS), a worldwide interoperability for microwave access (WiAMA) communication system, a 5^{th} generation (5G) system, or a new radio (NR). Furthermore, the technical solutions of the embodiments of the disclosure may be applied to future-oriented communication technologies.

It will be understood by those skilled in the art that “terminal” and “terminal equipment” as used herein include both a wireless signal receiver equipment having only a wireless signal receiver without a transmitting capability, and a receiving and transmitting hardware equipment having a receiving and transmitting hardware capable of performing bi-directional communication over a bi-directional communication link. Such equipment may include a cellular communication equipment or other communication equipment having a single line display or a multi-line display or having no multi-line display, a personal communications service (PCS) which may combine voice, data processing, facsimile and/or data communications capabilities, a personal digital assistant (PDA) which may include a radio frequency receiver, a pager, an Internet/Intranet access, a web browser, a notepad, a calendar, and/or a global positioning system (GPS) receiver, laptop and/or palmtop computers or other apparatus of the related art, having and/or including a radio frequency receiver. The “terminal”, “terminal equipment” used herein may be portable, transportable, mounted in a (air, sea and/or land) vehicle, or adapted and/or configured to operate locally, and/or on Earth and/or at any other location in space in a distributed form. The “terminal” and “terminal equipment” used herein may also be a communication terminal, an Internet access terminal, a music/video playback terminal, such as a PDA, a mobile Internet device (MID), and/or a mobile phone with music/video playback capabilities, and may also be a smart TV, a set-top box, and the like.

The term “transmitting” in the disclosure may be used in exchange for “transferring”, “reporting”, “notifying” and the like without departing from the scope of the disclosure.

The various embodiments of the disclosure are further described below in conjunction with the accompanying drawings. The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

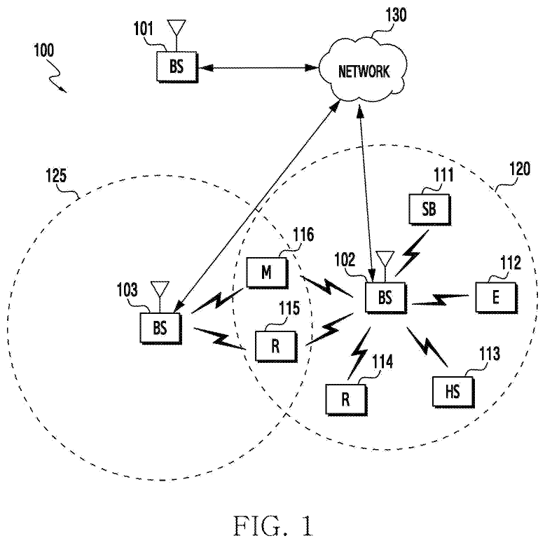

FIG. 1 illustrates a wireless network according to an embodiment of the disclosure.

Referring to FIG. 1, the embodiment of a wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a commonly considered fixed device (such as a desktop computer or a vending machine).

gNB 102 provides wireless broadband access to the network 130 for a first plurality of user equipment (UEs) within a coverage area 120 of gNB 102. The first plurality of UEs include a UE 111, which may be located in a small business (SB), a UE 112, which may be located in an enterprise (E), a UE 113, which may be located in a wi-fi hotspot (HS), a UE 114, which may be located in a first residence (R), a UE 115, which may be located in a second residence (R), a UE 116, which may be a mobile device (M), such as a cellular phone, a wireless laptop computer, a wireless PDA, or the like. gNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a 2D antenna array as described in embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

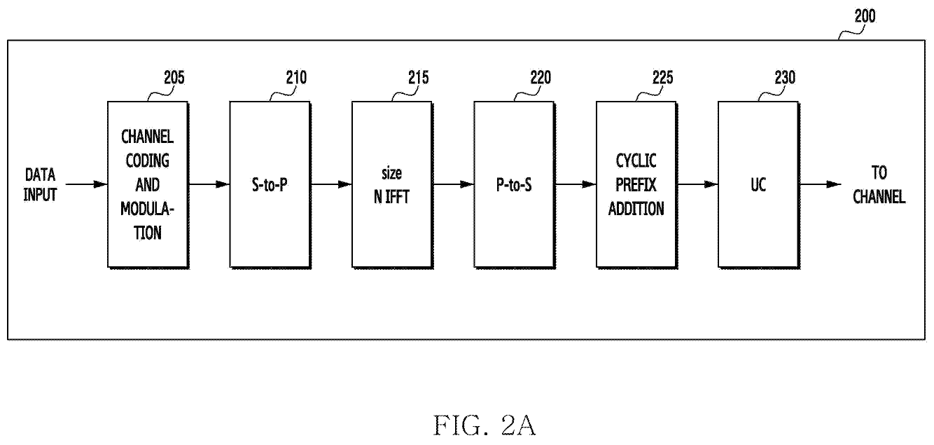

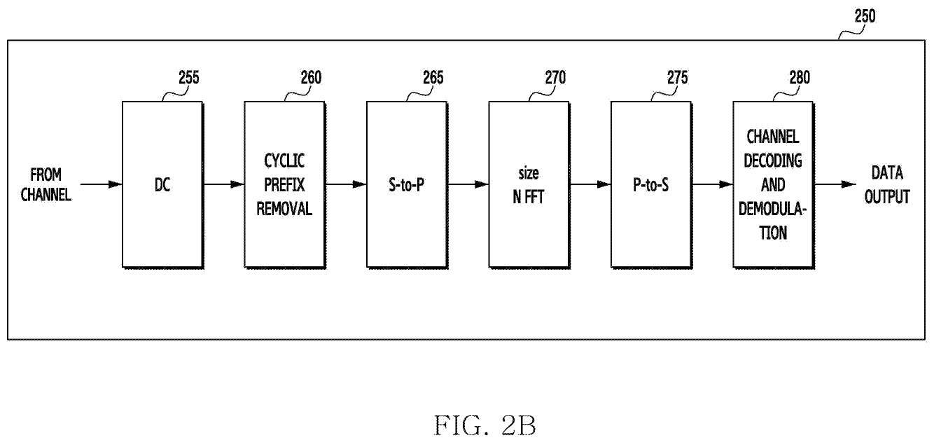

FIGS. 2A and 2B illustrate wireless transmission reception paths according to various embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments of the disclosure, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

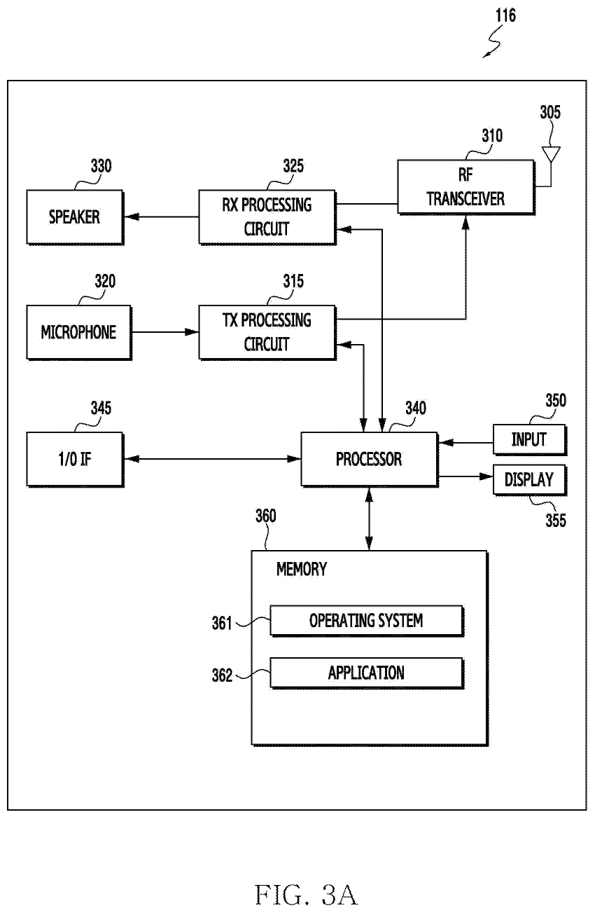

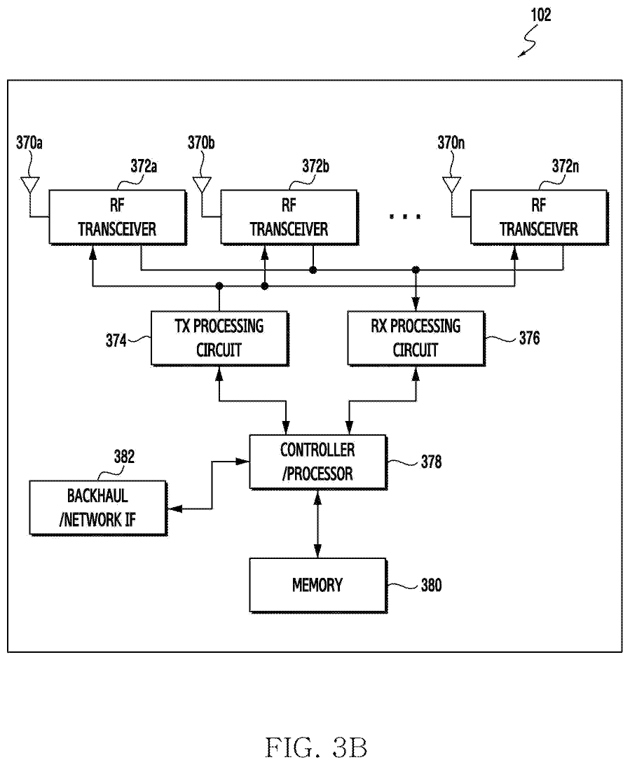

FIG. 3A illustrates a UE according to an embodiment of the disclosure.

Referring to FIG. 3A, the embodiment of a UE 116 is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments of the disclosure, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include random access memory (RAM), while another part of the memory 360 can include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3Aa illustrates that the UE 116 is configured as a mobile phone or a smart phone, UEs can be configured to operate as other types of mobile or fixed devices.

FIG. 3B illustrates a gNB according to an embodiment of the disclosure.

Referring to FIG. 3B, the embodiment of gNB 102 is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments of the disclosure, the controller/processor 378 supports communication between entities, such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include flash memory or other ROMs. In certain embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates a gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (which is also referred to as the time unit) in the disclosure may be an OFDM symbol, an OFDM symbol group (which consists of a plurality of OFDM symbols), a time slot, a time slot group (which consists of a plurality of time slots), a subframe, a subframe group (which consists of a plurality of subframes), a system frame, or a system frame group (which consists of a plurality of system frames). It may also be an absolute time unit, such as 1 millisecond, 1 second and the like. The time unit may also be a combination of multiple granularities, for example, N1 time slots plus N2 OFDM symbols.

The frequency domain unit (which is also referred to as the frequency unit) in the disclosure may be a subcarrier, a subcarrier group (which consists of a plurality of subcarriers), a resource block (RB) which may also be referred to as a physical resource block (PRB), a resource block group (which consists of a plurality of RBs), a bandwidth part (BWP), a bandwidth part group (which consists of a plurality of BWPs), a band/carrier, or a band group/carrier group. It may also be an absolute frequency domain unit, e.g., 1 Hz, 1 kHz, and the like. The frequency domain unit may also be a combination of multiple granularities, e.g., M1 PRBs plus M2 subcarriers.

The transmission link of a wireless communication system mainly includes a downlink from the 5G gNB to the user equipment (UE) and an uplink from the UE to the network.

The nodes used for positioning measurement in the wireless communication system (for example, the current wireless communication system) include a UE that initiates positioning request message, a location management function (LMF) that is used for positioning for the UE and downlink transmitting of positioning assistance data, a gNB or a transmission-reception point (TRP) that broadcasts positioning assistance data and performs an uplink positioning measurement and a UE for a downlink positioning measurement. In addition, the method of the disclosure may be extended to be applied in other communication systems, for example, vehicle to X (V2X), i.e., sidelink communication, wherein the TRP or UE may be any of the apparatuses in the V2X.

Regarding a positioning problem for communication, there are mainly two types of schemes, one of which is based on time estimation by measuring a time difference of arriving (TDOA) or round trip time (RTT), but the disadvantage of this type of scheme is that it leads to low positioning accuracy in a non-line-of-sight environment, and meanwhile the positioning accuracy is further reduced due to multipath characteristics of wireless channels and a synchronization error of the air interface. Another type of the schemes is based on angle estimation (for example, an angle of arrival (AOA), and an angle of departure (AOD), and the positioning accuracy of this scheme also depends on a calibration error between antennas and an angular resolution.

With the continuous evolution of wireless communication systems, the machine learning (ML) approaches are introduced to these problems in air interfaces, wherein, the ML approaches usually refer to algorithm design including machine learning and machine learning model design on which the algorithms are based. Solutions based on AI deep learning (DL) techniques usually refer to algorithms modelled on artificial neural networks in machine learning techniques. A deep learning network model usually consists of a plurality of layers of stacked artificial neural networks, adjusts weight parameters in the neural network by training existing data, and then are used in the inference phase to achieve tasks in an uncharted situation. Meanwhile, in general, compared with usual fixed-rule-based solutions or algorithms, DL-based solutions require better computing power than the original classical algorithms, which usually requires that an apparatus running the DL algorithms has a dedicated computing chip to support the DL algorithms to operate more efficiently.

Generally, certain conditions for the machine learning problem need to be satisfied in order to address issues encountered in communications by using AI algorithms based on machine learning. Among problems related to air interface that are present in communications, obtaining apparatus location is a typical problem that satisfies these conditions to a certain extent, and therefore may be addressed using machine learning algorithms and achieve better effect than traditional solutions in the communication transmission process, for example, in a non-line-of-sight environment.

Although positioning algorithms may provide normal services in some scenarios for today's used wireless communication systems, the use of machine learning algorithms is completely different from that of traditional algorithms due to their architecture and characteristics completely different from that of traditional algorithms. Since today's wireless communication systems (4^{th}, 5^{th}, and possibly 6^{th} generation wireless communication systems in the future) have strict and uniform standards for restricting configuration methods and behavioral processes of air interfaces during the communication process, considering the use of new techniques of machine learning in the new generation of wireless communication systems, the design of the air interface should be designed in conjunction with the characteristics of machine learning algorithms and the new communication systems, wherein for the implementation of machine learning based algorithms in the air interface of wireless communication systems, the specific implementation process needs to be specified, and how the signals are transmitted and interacted between the user equipment and the base station, the process of activating and deactivating the machine learning algorithms and models, and the updating of the machine learning algorithms and models during their use and the like are the key points to be considered.

Both tradition-based positioning and machine learning-based AI algorithms rely on measurements or estimates of the wireless channel which may be either the channel impulse response or the channel frequency response. For machine learning-based AI algorithms, the input of the model is a key consideration, how to choose appropriate measurements and appropriate sizes of input directly determines subsequent inference complexity of the model of the machine learning-based AI algorithms, positioning accuracy and signaling feedback overhead between the user equipment and air interface of the base station and between the base station and the location management function (LMF). In addition to being an input for inference of the AI model, how to choose appropriate measurements and appropriate sizes of input also influences the whole process of model supervision, updating, switching, activation, fallback and the like for the implementation of machine learning-based algorithms in the air interface of wireless communication systems.

In order to improve the positioning accuracy, for example, the accuracy may be improved directly based on a channel measurement or estimate CIR by increasing the sampling resolution in the time, space and frequency domains, but the ensuing problem is that a large number of channel measurements or estimates are required, which on the one hand, increases the processing complexity of subsequent systems including the computational complexity of the model inference, the complexity of the model (the parameters and the size of the model), and on the other hand, increases the signaling feedback overhead due to that the large amount of model input data needs to be interacted between the air interfaces. In addition, if the training entity of the AI model and the inference entity of the AI model are deployed on different apparatuses, model interaction is also required, larger models also increase the signaling overhead. Meanwhile, the increase in the amount of channel measurements used for training will dramatically increase the parameters and network complexity in the neural network, and also reduce the convergence rate of training and easily lead to training overfitting.

For example, in order to reduce the signaling overhead and/or reduce the complexity of the AI model, a truncated CIR method may be used. Specifically, the strongest N CIRs or the first N CIRs may be selected to be inputted into the AI model to obtain the location of the UE. However, such an approach results in less accurate positioning due to loss of path information and/or channel characteristics. Therefore, to obtain accurate positioning, N needs to be increased, which makes it still impossible to address the issues of high model complexity and high signaling overhead.

In addition, in actual environments, the collection of training data and the acquisition of labels for the trained data often requires a lot of time and human cost, while the collected channel measurements are often limited and labels are missing due to the limitations of the actual environments and the limitations of the collection apparatuses. Usually, the information collected for testing, which tends to be of high dimensionality, contains redundant and noisy information, which may introduce errors in practical applications and affect the accuracy of subsequent processing.

In order to reduce the dimensionality of the data input to the model, and at the same time ensure a certain positioning accuracy, it is necessary to carry out certain preprocessing on the measured channel information, and extract key feature information (for example, time information of the channel and/or the averaged energy-weighted arriving time information, and energy information of the channel and/or the averaged time-weighted energy information) that is strongly related to positioning to reduce the errors brought by the redundant information and noise information.

Therefore, based on the problems described above, in order to use machine learning based solutions in wireless communication systems, it is necessary to propose effective technical approaches to specify specific ways to implement these solutions in the system, including at least one of pre-processing of data, dimensionality of the data after pre-processing, selection of the model after pre-processing, and/or updating/supervision of the model and the like, to establish a suitable framework for the machine learning based approach to address air interface related issues in wireless communications.

In this paper, the first class method refers to methods for determining a location of a UE based on a machine learning model.

The second class method includes communication positioning methods of the related art, for example, time estimation based schemes and angle estimation based schemes and the like.

The disclosure provides a method for extracting feature information related to a channel based on, for example, a signature transform for information in a wireless communication system, wherein the extracted feature information is used for a subsequent operation of the wireless communication system. The subsequent operation is not limited to machine learning based UE positioning, but may be used for monitoring of a machine learning model for UE positioning, and can determine the location of the UE based on using the second class of methods.

Below, the technical solutions of the embodiments of the disclosure and the technical effects produced by the technical solutions of the disclosure will be explained by describing several optional embodiments. It should be noted that, the following embodiments may be referred to, imitated or combined with each other, and the same term, similar features and similar implementation steps in different embodiments will not be described repeatedly.

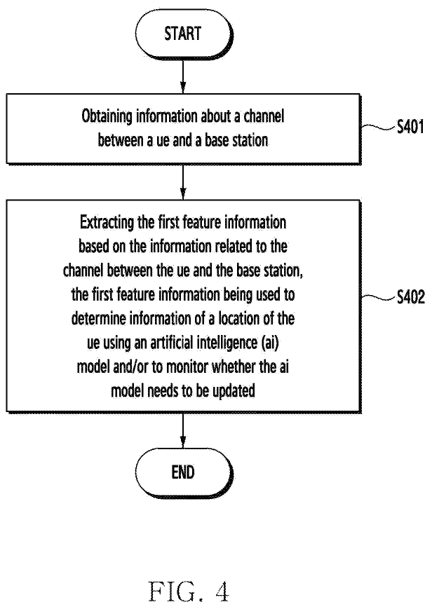

FIG. 4 illustrates a flowchart of a method performed by a first node in a wireless communication system according to an embodiment of the disclosure.

It should be understood by those skilled in the art that the first node may be a user equipment (UE), a base station, a location management function (LMF).

As an example, the LMF may be located in the base station.

Referring to FIG. 4, at operation S401, information about a channel between the UE and the plurality of base stations is obtained (for ease of description, hereafter, the information about the channel may also be referred to as information related to the channel).

As an example, if the method is performed by a network-side apparatus (e.g., a base station apparatus, an LMF), the network-side apparatus may trigger the measurement and/or acquisition of the positioning-related information (i.e., information about the channel) by obtaining a demand from a higher level (e.g., an application layer), and if the method is performed by a UE (e.g., a mobile phone, or a car in V2X, or the like), the UE may trigger the acquisition and/or measurement of positioning information (i.e., information about the channel) based on demands of its own higher level.

As an example, the information about the channel may indicate at least one of an uplink signal, a downlink signal, a channel impulse response (CIR) estimate value and a channel frequency response (CFR) estimate value.

As an example, the information about the channel may indicate a positioning reference signal (PRS), a sounding reference signal (SRS), or other reference signals in the wireless system, such as a synchronization signal block (SSB) and/or a channel state information-reference signal (CSI-RS) and the like.

As an example, the UE may communicate with M base stations and determine estimated values of CIR for the channel between the UE and the base stations based on signals transmitted between the UE and the base stations acquired at N moments. For example, N estimated values of CIR may be acquired at the N moments for each base station, and a total of N*M estimated values of CIR may be acquired at the N moments for the M base stations. The dimension of the N*M estimated values of CIR may be expressed as (M, N, 2) due to the fact that each CIR is represented by a complex number and the complex number includes a real part and an imaginary part.

For example, N estimate values may be obtained at the N moments for each base station, and a CIR estimate value at time t may be expressed as:

$$h ( t ) = {\sum }_{n = 1}^{N} ( {a}_{n} + j {b}_{n} ) δ ( t - {t}_{n} ) ,$$

wherein aₙ and bₙ indicate a real part and an imaginary part of impulse response for a nth multipath, and δ(t−tₙ) indicates an impulse function, 0<t₁< . . . tₙ₋₁<tₙ< . . . t_{N}, and wherein

$$δ ( t - {t}_{n} ) = \{ \begin{matrix}1 & t = {t}_{n} \\ 0 & t \neq {t}_{n}\end{matrix} \} .$$

As an example, an estimated value of CFR for a channel between the UE and each base station may be determined based on the obtained N estimated values of CIR corresponding to each base station, which is not repeated herein.

As an example, an estimated value of CFR corresponding to frequencies of subcarriers transmitting a signal between the UE and the base station may be determined. For example, the estimated values of CFR determined based on the N estimated values of CIR are continuous in frequency, and Y discrete CFR estimated values corresponding to frequencies of Y subcarriers may be determined from the continuous estimated values of CFR based on the frequencies of subcarriers. It should be understood by those skilled in the art that the obtained estimated values of CFR are complex values such that the dimension of the data is (M, Y, 2), wherein Y is the number of subcarriers.

At step S402, the first feature information is extracted based on the information related to the channel between the UE and the base station.

As an example, the first feature information may be related to energy and/or time of arrival of a multipath of the channel between the UE and the base station.

As an example, the first feature information includes at least one of feature information obtained by weighting time of arrival of a multipath of the channel between the UE and the base station based on energy of the channel between the UE and the base station, and feature information obtained by weighting the energy of the channel between the UE and the base station based on the time of arrival of the multipath of the channel between the UE and the base station.

As an example, the first node may extract the first feature information based on the information related to the channel by using a third rule (e.g., a signature transform).

It should be understood by those skilled in the art that the signature transform is only an example of the third rule and do not limit the disclosure.

As an example, the extracting of the first feature information may include determining multi-dimensional continuous values corresponding to the information related to the channel, and extracting the first feature information based on the multi-dimensional continuous values.

As an example, the determining of the multi-dimensional continuous values corresponding to the information related to the channel may include: transforming the information about the channel to one-dimensional continuous values based on, for example, a first rule (which may hereinafter be referred to as path reconstruction and/or continuous path generation), expanding the one-dimensional continuous values to the multidimensional continuous values based on, for example, a second rule (which may hereinafter be referred to as data augmentation, e.g., a d₁-dimensional values may hereinafter be referred to as d₁-dimensional paths).

As an example, when the information about the channel is indicative of a CIR estimate value, the obtaining includes obtaining N estimated values of CIR for N moments about the channel between the UE and each base station of a plurality of base stations, wherein the N moments are indicative of N discrete moments from a 1st moment to an Nth moment, performing a normalization operation on the N estimated values of CIR corresponding each base station to obtain N normalized estimated values of CIR.

As an example, the N estimated values of CIR corresponding to each base station may be normalized according to a predetermined rule. Specifically, a sum of squares of a real part and an imaginary part for the N estimated values of CIR may be calculated to obtain N sums of squares, a sum of the N sums of squares obtained from the calculating may be squared, and a value after the squaring dividing the kth CIR estimate may be used as a normalized estimated value corresponding to the kth CIR estimated value, thereby obtaining the N normalized estimated values of CIR.

It should be understood by those skilled in the art that the above-described normalization method is only an example and does not limit the disclosure.

As an example, the transforming of the information about the channel into the one-dimensional continuous values includes transforming the N normalized estimated values of CIR corresponding to each base station into N values corresponding to the N moments, and obtaining values corresponding to any moments between the first moment and the Nth moment based on the N values, so as to obtain the one-dimensional continuous values that are continuous from the first moment to the Nth moment.

As an example, N is a predefined value or is determined based on configuration information received from the base station.

As an example, the transforming of N estimated values of CIR corresponding to he each base station into the N values includes calculating a sum of squares of a real part and an imaginary part of each normalized estimated value of CIR to obtain N sums of squares, summing a first sum of squares to a kth sum of squares as a value corresponding to the kth estimated value of CIR (corresponding to the CSE solution described below), wherein k is greater than or equal to 1 and less than or equal to N, the wherein the obtaining of the values corresponding to the any moments between the first moment and the Nth moment based on the N values includes transforming the N values into one-dimensional continuous values based on linear interpolation.

As an example, N is a predefined value or determined based on configuration information received from the base station.

For example, the values corresponding to the N normalized estimated values of CIR (i.e., the values corresponding to the N moments) may be determined based on a cumulative sum energy (CSE) scheme represented by the following equation:

$$c ( t ) = {\sum }_{k = 1}^{n} \begin{matrix}{p}_{k} & n ∈ 1 , 2 , …\end{matrix} , N , t = {t}_{1} , {t}_{2} … , {t}_{N} ,$$

wherein, pₖ=aₖ²+bₖ², denotes energy of a kth path for the CIR (i.e., the kth CIR estimate value), aₖ and bₖ denotes a real part and an imaginary part of the kth path for the CIR.

As an example, a moment t0 may be added before the moment t1 to obtain c0 at the moment t0 and (c₀, t₀) is a 2-tuple zero vector, i.e.,

$${c}_{0} {=}^{Δ} 0 and {t}_{0} {=}^{Δ} 0 ,$$

which is referred to as basepoint augmentation.

It should be appreciated by those skilled in the art that the purpose of the basepoint augmentation is to make an alignment for the starting point of each time-augmented CSE sequence. By aligning the basepoint, the integrity of time and energy information is kept, especially in case of CIRs with the first tap having the highest energy. This is because some signature features require computation for the difference between the endpoint and the starting point of the time-augmented CSE sequence, and the information of the starting point is lost it there is no basepoint alignment.

For example, the linear interpolation may be expressed by the following equation:

$$c ( t ) = \frac{{c}_{n} - {c}_{n - 1}}{{t}_{n} - {t}_{n - 1}} ( t - {t}_{n} ) + {c}_{n - 1} , {t}_{n - 1} \leq t \leq {t}_{n} ,$$

wherein c (t) denotes a value corresponding to a moment t, and cₙ and cₙ₋₁ denote values corresponding to tₙ (i.e., the n^{th} moment) and tₙ₋₁ (i.e., the n−1^{th} moment), respectively (i.e., c, denotes a sum of the first sum of squares to the n^{th} sum of squares, cₙ₋₁ denotes a sum of the first sum of squares to the n−1^{th} sum of squares).

It should be understood by those skilled in the art that the above first rule based on the CSE and the linear interpolation is only an example and does not limit the disclosure.

As an example, the expanding of the one-dimensional continuous values into the multi-dimensional continuous values may include performing data augmentation on the one-dimensional continuous values corresponding to each base station over a predetermined domain to expand the one-dimensional continuous values into the multi-dimensional continuous values.

As an example, the performing of data augmentation on the one-dimensional continuous values corresponding to each base station over the predetermined domain to expand the one-dimensional continuous values into the multi-dimensional continuous values may include: performing data augmentation on the one-dimensional continuous values corresponding to each base station over d₁−1 predetermined domains to expand the one-dimensional continuous values into d₁-dimensional values, wherein d₁ is greater than or equal to 2.

As an example, when the information about the channel indicates an estimated value of CIR, the predetermined domain includes a time domain, and/or when the information about the channel indicates an estimated value of CFR, the predetermined domain includes a frequency domain.

For example, d-dimensional values (or d-dimensional continuous values) may be represented as:

$$X ( t ) = \{ {X}_{1} ( t ) , {X}_{2} ( t ) , … , {X}_{d} ( t ) \} : [ a , b ] \to {ℝ}^{d} ,$$

which may indicate a continuous mapping from an interval [a,b] to [symbol] ^{d}, X(t) may be referred to as a path (or d-dimensional paths) herein. For ease of description, it may be abbreviated as X.

As an example, a dimension expansion operation may be performed on the obtained one-dimensional continuous values over the time domain to expand the one-dimensional continuous values into two-dimensional continuous values as shown in the following equation:

$$X ( t ) = \{ \begin{matrix}{X}_{1} ( t ) = {c}_{1} ( t ) \\ {X}_{2} ( t ) = t\end{matrix} .$$

It should be understood by those skilled in the art that the multi-dimensional values described herein means that values of each dimension are continuous in a particular dimension of the multiple dimensions.

For example, c (t) (i.e., continuous values in one dimension) is continuous in time (i.e., a particular dimension), that is, there exists a corresponding c (t) for any moment t, (i.e., continuous values on another dimension) is continuous in time, that is, there exists a corresponding t for any moment t.

It should be understood by those skilled in the art that multi-dimensional continuous values may mean the multi-dimensional continuous values being continuous on an interval of the particular dimension. For example, X₁(t) and X₂(t)=t are continuous over, for example, the time interval (t₀, t_{N}).

Those skilled in the art should be understood that in addition to expanding the one-dimensional continuous values in the time domain, the expanding may be performed on the one-dimensional continuous values in other domains, for example, the one-dimensional continuous values are expanded in a frequency domain, or in an angle domain.

In addition, although the above example expands the one-dimensional continuous values (i.e., X₁(t)=c(t)) into two-dimensional continuous values (i.e., X₁ (t)=c(t), X₂(t)=t) only in the time domain, it should be understood by those skilled in the art that the one-dimensional continuous values may be expanded into more dimensional continuous values.

For example, the one-dimensional continuous values may be expanded to be three-dimensional continuous values as follows:

$$X ( t ) = \{ \begin{matrix}{X}_{1} ( t ) = {c}_{1} ( t ) \\ {X}_{2} ( t ) = {c}_{2} ( t ) \\ {X}_{3} ( t ) = t\end{matrix} ,$$

wherein c₁(t) and c₁(t) may be indicative of components in both directions of c (t).

It should be understood by those skilled in the art that the first rule and the second rule described above are only examples and do not limit the disclosure.

For example, the continuous path generation may be performed using a rectilinear interpolation method, a lead-lag transformation, a DFT transform, or the like, or a combination thereof.

As an example, the first rule and the second rule may be determined by receiving high-level information.

It should be understood by those skilled in the art that performing a signature transform on the data described herein indicates performing certain form of transform on the data to extract feature information for subsequent processing or for a particular purpose.

As an example, a signature transform may be performed for multi-dimensional continuous values corresponding to each base station, or multi-dimensional continuous values corresponding to the plurality of base stations to obtain the feature information.

As an example, the extracting of the first feature information based on the multi-dimensional continuous values (which may hereinafter be referred to as the signature transforming includes obtaining feature information of d₁-dimensional values corresponding to each base station, wherein the feature information includes k₁ levels of features, wherein the i₁th-level feature of the k₁ levels of features is obtained by integrating i₁ dimensions of information among d₁ dimensions of information over a time range from a first moment to an Nth moment, wherein k₁ is greater than or equal to 1 and i₁ is greater than or equal to 1, obtaining feature information of M*d₁-dimensional values corresponding to M base stations, wherein the feature information includes k₂ levels of features, wherein the i₂th-level feature of the k₂ levels of features is obtained by integrating i2 dimensions of information among the M*d₁ dimensions of information over a time range from the first moment to the Nth moment, wherein k₂ is greater than or equal to 1, i₂ is greater than or equal to 1.

As an example, the signature transform processing may represent constructing an infinitely long sequence/or a truncated sequence by performing an integral transform operation on the reconstructed path (or multi-dimensional continuous values).

If the signature transform is performed on multi-dimensional continuous values (e.g., a d-dimensional path) corresponding to each base station, the sequence may be represented as:

$$S ( X ) = ( 1 , {S ( X )}_{1} , {S ( X )}_{2} , … , {S ( X )}_{d} , {S ( X )}_{1 , 1} , {S ( X )}_{1 , 2} , \text{} … , {S ( X )}_{1 , d} , … , {S ( X )}_{d , d} , {S ( X )}_{1 , 1 , 1} , … , {S ( X )}_{{i}_{2} , {i}_{2} , … , {i}_{k}} , … ) , \\ wherein , \\ {S ( X )}_{{i}_{1} , {i}_{2} , … , {i}_{k}} = \int … \int {\prod }_{m = 1}^{k} \frac{{dX}_{{i}_{m}}}{dt} ( {τ}_{m} ) d {τ}_{1} d {τ}_{2} … d {τ}_{k} ( {i}_{1} , {i}_{2} , … , {i}_{k} ) ∈ {\{ 1 , 2 , … , d \}}^{k} ,$$

wherein iₘ denotes an iₘ th dimension of the d-dimensional path, τₘ denotes an integration interval of an m^{th} dimensional data of the d-dimensional paths, the first item in the sequence is a 0^{th}-level signature, S(X)ᵢ_{₁}_{, i}_{₂}_{, . . . , i}_{ₖ} denotes a k^{th}-level signature, wherein d denotes a number of dimensions of the multi-dimensional continuous values corresponding to each base station obtained by the second rule, and in this case each base station corresponds to one sequence described above, and a and b may denote an upper bound and a lower bound of a time range. For example, a may denote time t₁ corresponding to the first moment, and t₁ may for example be equal to 0, and b may denote time t_{N} corresponding to the Nth moment.

If the signature transformation is performed for a reconstructed path corresponding to the M base stations, the sequence may be represented as:

$$S ( X ) = ( 1 , {S ( X )}_{1} , {S ( X )}_{2} , … , {S ( X )}_{Md} , {S ( X )}_{1 , 1} , {S ( X )}_{1 , 2} , \text{} … , {S ( X )}_{1 , d} , … , {S ( X )}_{Md , Md} , {S ( X )}_{1 , 1 , 1} , … , {S ( X )}_{{i}_{2} , {i}_{2} , … , {i}_{k}} , … ) , \\ Wherein \\ {S ( X )}_{{i}_{1} , {i}_{2} , … , {i}_{k}} = \int … \int {\prod }_{m = 1}^{k} \frac{{dX}_{{i}_{m}}}{dt} ( {τ}_{m} ) d {τ}_{1} d {τ}_{2} … d {τ}_{k} ( {i}_{1} , {i}_{2} , … , {i}_{k} ) ∈ {\{ 1 , 2 , … , Md \}}^{k}$$

wherein iₘ denotes an iₘ^{th} dimension of an Md-dimensional path, τₘ denotes an integration interval of an m^{th}-dimensional data of the M*d-dimensional path, the first term of the sequence is a 0^{th}-level signature, S(X)ᵢ_{₁}_{, i}_{₂}_{, . . . , i}_{ₖ} denotes a kth-level signature, wherein d denotes a number of dimensions of the multi-dimensional continuous values corresponding to each base station obtained by the second rule, Md is a number of dimensions corresponding to the M base stations (i.e., one base station corresponds to d-dimensional continuous values, and M base stations correspond to Md-dimensional continuous values), and a and b may denote an upper bound and a lower bound of a time range. For example, a may denote time t₁ corresponding to the first moment, and t₁ may for example be equal to 0, and b denotes time t_{N} corresponding to the Nth moment, wherein the plurality of base stations corresponds to one sequence described above.

For example, the one-dimensional continuous values may be expanded to be 2-dimensional continuous values through the data augmentation (e.g., one dimension represents values of the one-dimensional continuous values and another dimension represents time). If the feature information is obtained for the 2-dimensional paths corresponding to each base station, the first-level features are a value obtained by integrating the values of the one-dimensional continuous values over a time range from the first moment to the N^{th} moment and a value obtained by integrating the time over the time range from the first moment to the N^{th} moment. The 2^{nd}-level features are a value obtained by integrating the values of the one-dimensional continuous values twice over the time range from the first moment to the N^{th} moment, a value obtained by integrating the time twice in the time range from the first moment to the N^{th} moment, a value obtained by integrating the values of the one-dimensional continuous values and the time sequentially in the time range from the first moment to the N^{th} moment, and a value obtained by integrating the time and the values of the one-dimensional continuous values sequentially in the time range from the first moment to the N^{th} moment. The 3^{rd} level features may include a value obtained by integrating the values of the one-dimensional continuous values three times in the time range from the first moment to the N^{th} moment, a value obtained by integrating time by three times in the time range from the first moment to the N^{th} moment, a value obtained by integrating the values of the one-dimensional continuous values, the time and the values of the one-dimensional continuous values sequentially in the time range from the first moment to the N^{th} moment, a value obtained by integrating the values of the one-dimensional continuous values, the time, and the time sequentially in the time range from the first moment to the N^{th} moment, a value obtained by integrating the values of the one-dimensional continuous values, the values of the one-dimensional continuous values and the time sequentially in the time range from the first moment to the N^{th} moment, a value obtained by integrating the time, the values of the one-dimensional continuous values and time sequentially in the time range from the first moment to the N^{th} moment, a value obtained by integrating the time, the values of the one-dimensional continuous values and the values of the one-dimensional continuous values sequentially in the time range from the first moment to the N^{th} moment, and a value obtained by integrating the time, the time and the values of the one-dimensional continuous values in the time range from the first moment to the N^{th} moment.
As an example, if the feature information is obtained for a 6 (i.e., 3*2)-dimensional paths corresponding to, for example, 3 base stations, the 1st-level feature is a value obtained by integrating 1 dimension of information selected from the 6-dimensional information over a time range from the first moment to the Nth moment, that is, the 1st-level feature may include 6 values. Similarly, the 2^{nd}-level feature may be obtained by integrating 2 dimensions information among the 6-dimensional information over the time range.
With respect to the above sequence, in the sequence obtained by performing a signature transform on the multi-dimensional continuous values corresponding to each base station, the first term may be 1, there are d 1st-level signature features, d² 2^{nd}-level signature features, and d^{N}^{₁} N₁^{th}-level signature features.

For example, 2 levels of signatures S (X) for a 2-dimensional paths (i.e., d₁=2) may be expressed as:

$${[ S ( X ) ]}_{2} = ( 1 , {S}_{1} , {S}_{2} , {S}_{1 , 1} , {S}_{1 , 2} , {S}_{2 , 1} , {S}_{2 , 2} ) , \\ wherein , {S}_{1 , 2} + {S}_{2 , 1} = {S}_{1} {S}_{2} \\ {S}_{i , i} + {S}_{2 , 1} = {S}_{1} {S}_{2} \\ {S}_{i , i} + {S}_{i , i} = {S}_{i}^{2} ∈ \{ 1 , 2 , … , d \} ,$$

and wherein a number of the first-level signature features is 2 and a number of the second-level features is 4.

According to embodiments of the disclosure, when the feature information is not extracted, the dimension of the information about the channel may be expressed as (M, N, 2), and after expanding the one-dimensional continuous values into two-dimensional continuous values and extracting the 2 levels of feature information, the dimension of the information about the channel becomes (M, 6). As can be seen, the original data is simplified.

For example, the signature transform is performed on the augmented data corresponding to each base station, and the 1^{st}-level signature features S1 and S2 and the 2^{nd}-level signature features S_{2,1}, S_{1,2} of the 2 levels of signature features may be computed by the following equation:

$${S}_{1} = {\int }_{0}^{{t}_{N}} dc ( t ) = c ( {t}_{N} ) - {c}_{0} = {c}_{N} \\ {S}_{2} = {\int }_{0}^{{t}_{N}} dt = {t}_{N} - {t}_{0} = {t}_{N} \\ {S}_{2 , 1} = {\int }_{0}^{{t}_{N}} {\int }_{0}^{{τ}_{2}} d {τ}_{1} dc ( {τ}_{2} ) = {\int }_{0}^{{t}_{N}} {τ}_{2} dc ( {τ}_{2} ) = {\sum }_{n = 1}^{N} \frac{{t}_{n} + {t}_{n - 1}}{2} {p}_{n} \\ {S}_{1 , 2} = {\sum }_{n = 1}^{N} ( {t}_{n} - {t}_{n - 1} ) ( {c}_{n - 1} + \frac{1}{2} {p}_{n} ) \\ {p}_{n} = {a}_{n}^{2} + {b}_{n}^{2} .$$

Since the signature transform may only be applied to continuous, bounded transform paths, the paths are constructed from the normalized estimated values of CIR.

A straightforward approach is to interpolate the real part and the imaginary part of the normalized CIR to construct a 2D path. However, this may lose some temporal information due to the time-invariant nature of the signature transform.

Another simple and straightforward method is to construct a CFR path. The path generation for the CFR requires converting signals from a time domain to a frequency domain by the discrete Fourier (DFT) transform, but with the signature transform, the frequency domain information will be interfered by phase information, which cannot retain critical signal energy and time information and only satisfies the need for a certain level of accuracy in positioning accuracy.

Therefore, in order to make the signature transform reflect time information, this document transforms the normalized estimated values of CIR into continuous multi-dimensional values based on the CSE and data augmentation for the time domain to reflect the time information when performing the signature transform, so as to make the obtained feature information more reflective of the changes in the location of the UE, and thus enable a more accurate determination of the location of the UE.

According to embodiments of the disclosure, data augmentation may be performed on the raw discrete data (e.g., estimated values of CIR), and then the signature transform and/or the logarithmic signature transform may be used to obtain useful time-energy-weighted features, and then some features may be selected based on a predefined criteria or capabilities of an AI model from among useful features to be inputted into the AI model to obtain the location of the UE.

As an example, a normalized processing operation may also be performed on the selected feature information, and the normalized features may be input into the AI model to determine the location of the UE.

It should be understood by those skilled in the art that the above-described ways of extracting feature information are only examples and do not limit the disclosure.

The method described in FIG. 4 may further include: performing compression on the first feature information and taking the compressed features as the first feature information, or performing compression on the first feature information and selecting a part of the compressed features as the first feature information, or selecting a part of features in the first feature information as the first feature information.

Since the signature features are not independent of each other, redundant information in the signatures may be removed by a compression operation to obtain a more compact form.

As an example, the compression operation may be performed based on a fourth rule.

As an example, the fourth rule may be a logarithmic transform, but is not limited thereto.

As an example, the logarithmic transform may be represented by the following equation:

$$log ( S ) {=}^{△} {\sum }_{m = 1}^{∞} \frac{{( - 1 )}^{( m - 1 )}}{m} {( S - 1 )}^{{⊗}_{m}}$$

wherein 1=(1, 0, 0 . . . ), ⊗ denotes a tensor operation.

For example, 2 levels of truncated signatures for 2-dimensional paths before being transformed based on the logarithmic transform is:

$$( 1 , {S}_{1} , {S}_{2} , {S}_{1 , 1} , {S}_{1 , 2} , {S}_{2 , 1} , {S}_{2 , 2} ) , \\ when m = 2 , \\ {( {S}_{1} , {S}_{2} , {S}_{1 , 1} , {S}_{1 , 2} , {S}_{2 , 1} , {S}_{2 , 2} )}^{{⊗}_{2}} = {S}_{1} {S}_{1} + {S}_{1} {S}_{2} + {S}_{2} {S}_{1} + {S}_{2} {S}_{2} , \\ when m = 2 , \\ \begin{matrix}{[ log ( S ) ]}_{2} = ( {S}_{1} , {S}_{2} , {S}_{1 , 1} , {S}_{1 , 2} , {S}_{2 , 1} , {S}_{2 , 2} ) - \frac{1}{2} ( {S}_{1} {S}_{1} + {S}_{1} {S}_{2} + {S}_{2} {S}_{1} + {S}_{2} {S}_{2} ) \\ = ( {S}_{1} , {S}_{2} , \frac{1}{2} ( {S}_{1 , 2} - {S}_{2 , 1} )\end{matrix} , \\ wherein {S}_{i , i} + {S}_{i , i} = {S}_{i}^{2} i ∈ ( 1 , 2 , … , d ) ,$$

and the 2 level truncated signatures for the 2-dimensional paths after being transformed based on the logarithmic transform is:

$${[ log ( S ) ]}_{2} = ( {S}_{1} , {S}_{2} , 0.5 ( {S}_{1 , 2} - {S}_{2 , 1} ) ) .$$

As an example, lower-level signatures S, and s, after the logarithmic transform may be removed, and the dimension of the data becomes (M, 1), so that the data with the dimension may be utilized to determine the location of the UE.

For example, 2 level logarithmic signature features obtained by performing the signature transform for the augmented data corresponding to each base station is:

$${[ log ( S ) ]}_{2} = ( {S}_{1} , {S}_{2} , 0.5 ( {S}_{1 , 2} - {S}_{2 , 1} ) ) .$$

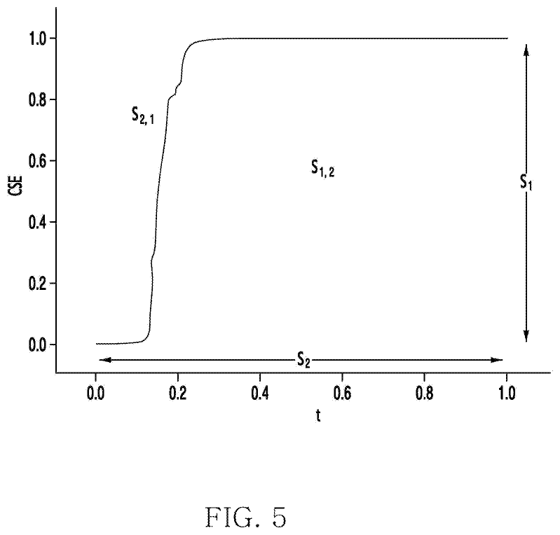

FIG. 5 illustrates geometric meaning of some of signature transform features obtained based on the signature transform described above according to an embodiment of the disclosure.

Referring to FIG. 5, S₁ is an energy span of the path, which is 1^{st}-level statistic information of energy of the path, is equal to total energy of CIRs, and contains information about large-scale fading (e.g., path loss and shadowing). S₁ for CIRs with large path loss and shadow fading is small. S₂ is a time span of the path, which is 1st-level statistic information of the time of the path, and it contains time for CIRs. CIRs with large absolute delays and delay extensions will have large S₂. S_{1,2} is a two-dimensional space consisting of energy and time, and the area of region below the path (the curve in the figure) is 1st-level statistic information of time and energy of the path that represents average time-weighted energy of the path. It contains information about the LOS-tap of the CIR. S_{2,1} is also a two-dimensional space consisting of energy and time, the area of region above the path also contains information about the LOS-tap of the CIR. From an algebraic point of view, S_{2,1} is equal to a sum of energy-weighted times, and the times have additional linear interpolation times. From a probabilistic point of view, S_{2,1} may be interpreted as the average time of arrival of the CIRs. The area of the regions of S_{2,1} and S_{1,2} may reflect the probability of containing a LOS tap in the CIRs, and may be used to classify different channel features, such as LOS and NLOS channels. For example, the area of the region of S_{1,2} in a LOS scenario is larger than the area of the region of corresponding S_{1,2} in a NLOS scenario, the ratio of the area of the region of S_{1,2} to the area of the region of S_{2,1} in the LOS scenario is larger than the corresponding ratio of the area of the region of S_{1,2} to the area of the region of S_{2,1} in the NLOS scenario, the area of the region of S_{2,1} in the LOS scenario is smaller than the area of the region of corresponding S_{2,1} in the NLOS scenario which implies that in the LOS scenario, the CIR has a larger energy weight at small time indices, while in the NLOS scenario, the CIR has more energy weight at large time indices. This makes S_{2,1} to be a very useful metric for classification between LOS and NLOS.

Thus, it may be determined whether the communication between the UE and the base station is a line-of-sight communication or a non-line-of-sight communication based on a particular feature (e.g., S_{2,1}) of the acquired feature information.

According to embodiments of the disclosure, the particular features in the feature information for the wireless communication channel are different in different scenarios, and thus, the channel may be distinguished based on information for the particular features. Compared to an AI model trained to determine the location of a UE based on raw CIRs or truncated CIRs, the AI model of the disclosure trained based on weighted time-energy feature information (e.g., a first feature information or a second feature information) may better learn the mapping relationship between the location of the UE and the channel characteristics, and thus better localize the UE.

For example, a signature transform is performed for the augmented data corresponding to each base station and 4 level logarithmic signature features are:

$$\begin{matrix}{[ log ( S ) ]}_{4} = {\sum }_{m}^{4} \frac{{( - 1 )}^{( m - 1 )}}{m} {( {[ S ]}_{4} - 1 )}^{{⊗}_{m}} \\ = [ \overline{S} - \frac{1}{2} {\overline{S}}^{{⊗}_{2}} + \frac{1}{3} {\overline{S}}^{{⊗}_{3}} - \frac{1}{4} {\overline{S}}^{{⊗}_{3}} ] \\ = {λ}_{1} {e}_{1} + {λ}_{2} {e}_{2} + {λ}_{1 , 2} {e}_{1 , 2} + {λ}_{1 , 1 , 2} {e}_{1 , 1 , 2} + {λ}_{1 , 2 , 2} {e}_{1 , 2 , 2} + {λ}_{1 , 1 , 1 , 2} {e}_{1 , 1 , 1 , 2} + \\ {λ}_{1 , 1 , 2 , 2} {e}_{1 , 1 , 2 , 2} + {λ}_{1 , 2 , 2 , 2} {e}_{1 , 2 , 2 , 2}\end{matrix}$$

wherein, S̅=S−1, e₁, . . . , e_{1,2,2,2} are corresponding subscripts, λ₁, . . . , λ_{1,2,2,2} are coefficients corresponding to corresponding 4 level signature, wherein

$${λ}_{1} = {c}_{N} , \\ {λ}_{2} = {t}_{N} , \\ {λ}_{1 , 2} = \frac{1}{2} {\sum }_{n = 1}^{N} {p}_{n} ( {t}_{N} - {t}_{n} - {t}_{n - 1} ) , \\ {λ}_{1 , 1 , 2} = {\sum }_{n = 1}^{N} ( {t}_{n} - {t}_{n - 1} ) ( \frac{1}{2} {c}_{n - 1}^{2} + \frac{1}{2} {c}_{n - 1} ( {p}_{n} - {c}_{N} ) + \frac{1}{6} {p}_{n}^{2} - \frac{1}{4} {c}_{N} {p}_{n} ) + \frac{1}{12} {c}_{N}^{2} {t}_{N} , \\ {λ}_{1 , 2 , 2} = \frac{1}{12} {\sum }_{n = 1}^{N} {p}_{n} ( {t}_{N}^{2} + 2 {t}_{n}^{2} + 2 {t}_{n - 1}^{2} + 2 {t}_{n} {t}_{n - 1} - 3 {t}_{N} ( {t}_{n} + {t}_{n - 1} ) ) , {λ}_{1 , 1 , 1 , 2} = {\sum }_{n = 1}^{N} ( {t}_{n} - {t}_{n - 1} ) ( \frac{1}{6} {c}_{n - 1}^{3} + \frac{1}{4} {c}_{n - 1}^{2} ( {p}_{n} - {c}_{N} ) + \frac{1}{12} {c}_{n - 1} ( {c}_{N} - {p}_{n} ) ( {c}_{N} - 2 {p}_{n} ) + \frac{1}{24} {{p}_{n} ( {p}_{n} - {c}_{N} )}^{2} ) , \\ {λ}_{1 , 1 , 2 , 2} = \frac{1}{24} {c}_{N}^{2} {t}_{N}^{2} + {\sum }_{n = 1}^{N} {p}_{n} ( {t}_{n}^{2} ( 2 {c}_{N} - {p}_{n} ) + {t}_{n - 1}^{2} ( 2 {c}_{N} - 3 {p}_{n} ) + 2 {t}_{n} {t}_{n - 1} ( {c}_{N} - {p}_{n} ) - 2 {t}_{N} {t}_{n} ( 2 {c}_{N} - {p}_{n} ) - 4 {t}_{n - 1} {t}_{N} ( {c}_{N} - {p}_{n} ) ) + {\sum }_{n = 1}^{N} {p}_{n} {\sum }_{k = 1}^{n - 1} ( \frac{1}{4} {p}_{k} {t}_{N} ( {t}_{k} + {t}_{k - 1} ) - \frac{1}{6} {p}_{k} ( {t}_{k}^{2} + {t}_{k} {t}_{k - 1} + {t}_{k - 1}^{2} ) ) , \\ {λ}_{1 , 2 , 2 , 2} = \frac{1}{24} {\sum }_{n = 1}^{N} {p}_{n} ( 2 {t}_{N} {t}_{n - 1}^{2} - ( ( {t}_{n} + {t}_{n - 1} ) ( {( {t}_{N} - {t}_{n} )}^{2} + {t}_{n - 1}^{2} ) ) .$$

The geometrical meanings of the signature transform features obtained based on the signature transform described above are as follows:

λ₁ represents an energy span of the path which is 1^{st}-level statistical information of energy;

λ₂ represents a time span of the path which is 1^{st}-level statistical information of time;

λ_{1,2} represents energy-weighted time of the path, which is 1^{st}-level statistical information of time and energy;

λ_{1,1,2} represents time-weighted energy of the path, which is 2^{nd}-level statistical information of energy;

λ_{1,2,2} represents energy-weighted energy of the path, which is 2^{nd}-level statistical information of time;

λ_{1,1,1,2} represents a cubic polynomial of energy of the path, which is 3^{rd}-level statistical information of the energy;

λ_{1,1,2,2} represents a quadric polynomial of time and energy of the path which is 2^{nd}-level statistical information of time and energy;

λ_{1,2,2,2} represents a cubic polynomial of time of the path which is 3^{rd}-level statistical information of the time.

According to embodiments of the disclosure, key features reflecting the location of the UE are retained more compactly by the logarithmic signature transformation, and the dimensionality of the features is reduced, and thus subsequent utilization of the features is facilitated.

As an example, the selecting of the part of the compressed features as the first feature information, or the selecting of the part of the features of the first feature information as the first feature information includes: selecting the part of the compressed features as the first feature information, or selecting the part of features in the first feature information as the first feature information, based on at least one of a predefined criteria, configuration information configured by the base station, or location management function (LMF), processing capability of the AI model, a type of the UE and/or a type of the base station, the information related to the channel, and the first feature information.

Thus, when referring to the first feature information hereinafter, the first feature information may refer to one of the first feature information extracted based on the information related to the channel, a portion of the first feature information extracted based on the information related to the channel, the first feature information that has been compressed, a portion of the compressed first feature information, and a portion of feature information selected from the compressed first feature information.

As an example, the information related to the channel includes at least one of a number of multipaths for CIR and time length for CIR values. As an example, the first rule, the second rule, the third rule, the fourth rule and/or the fifth rule described above are predetermined, determined based on configuration information received from the base station or the LMF, or determined based on processing capabilities of the AI model.

As an example, the selecting may be performed based on the ability to support a number of input features that the AI model has.

As an example, the selecting may be performed based on features according to the measured CIRs.

As an example, the selecting may be performed based on features of the measured CIR dataset.

For example, when the AI/ML model is deployed on an IoT terminal, the computing and processing capability and the required positioning accuracy of the IoT terminal are low, and the IoT terminal has an ability to support a lesser number of features (such as, 2 or 4) as inputs to the model due to a power consumption limitation of the IoT terminal, and thus only 2 or 4 features are selected as inputs to the AI model from among the first feature information. When the AI/ML model is deployed on a network apparatus that has strong computing and processing capability, without limitation on power consumption and computational complexity, as well as the capability to support a larger number of features (such as, 6 or 8) as inputs to the model, and then 6 or 8 features of the first feature information may be selected as inputs to the AI model.

For example, when the number of multipaths of the inputted CIRs used for the feature extraction N is less than or equal to 2, the higher-level energy-time weighted features (e.g., the 3^{rd}-level statistics of energy and time) may be discarded, because the lower-order energy-time weighted features already contain important information for determining the location of the UE.

When the number of multipaths of the inputted CIRs used for feature extraction N is greater, the higher-level energy-time weighted features may be provided to satisfy a higher positioning accuracy, and thus the lower-level weighted energy-time features may be discarded.

For example, when each CIR in the dataset has the same time length, or when each CIR is normalized, the lower-level or higher-level weighted energy-time features may be discarded.

After the feature selection, the mean-variance normalization is performed on a set of features to construct the features with zero mean and unit variance, and then fed the constructed feature into AI model to train the AI model.

According to embodiments of the disclosure, the selection operation retains a more compact set of key features reflecting the UE location and reduces the dimensionality of the features, and thus facilitates subsequent utilization of the features. For example, the complexity of subsequent calculations (e.g., determining location of the UE and/or determining whether the AI model needs to be updated) is reduced.

As an example, the first feature information may be used to determine information of a location of the UE using the AI model and/or to monitor whether the AI model needs to be updated.

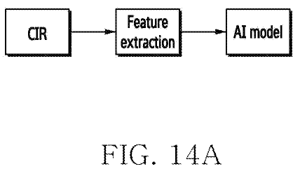

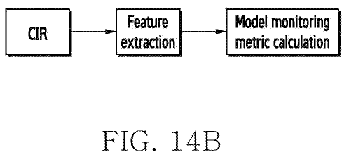

FIGS. 14A and 14B illustrate a schematic diagram of a method for determining location of a UE using an AI model and monitor the AI model according to an embodiment of the disclosure.

Referring to FIG. 14A, based on CIR information, the feature information is extracted, and fed the extracted feature as input into the AI model to determine the UE location.

Furthermore, referring to FIG. 14B, based on the extracted feature, the AI model monitoring metric can be calculated. Based on calculated monitoring metric, it can be used to determine whether the AI model is updated or not (detailed description will be provided later below).

The determining of the location of the UE and/or to the determining of whether the AI model needs to be updated may be based on other channel related information. Those skilled in the art should understand that the AI models, machine learning models, and neural network models described herein may have the same or similar meanings and may be substituted for each other.

As an example, the method shown in FIG. 4 may further include at least one of: determining the information of the location of the UE by using a first AI model based on the first feature information, determining second feature information by using a second AI model based on the first feature information, and determining the information of the location of the UE based on the second feature information, transmitting the first feature information to a second node to facilitate the second node to determine the information of the location of the UE by using the first AI model based on the first feature information, or determine second feature information by using a second AI model based on the first feature information and determine the information of the location of the UE based on the second feature information, determining second feature information by using a second AI model based on the first feature information, transmitting the second feature information to the second node to cause the second node to determine the information of the location of the UE based on the second feature information, wherein the first node is a UE and the second node is a base station or an LMF; or the first node is a base station and the second node is a UE or an LMF.

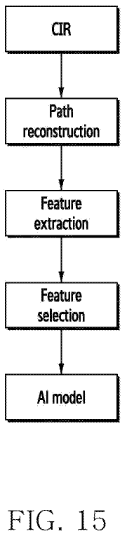

FIG. 15 illustrates a schematic diagram of a method for determining a location of a UE according to an embodiment of the disclosure.

Referring to FIG. 15, a feature used for determining the location of the UE by the AI model is obtained based on the CIR information. Specifically, features for determining the location of the UE may be acquired by path reconstruction, feature extraction, and feature selection based on the CIR information. The selected features are then input into the AI model to determine the location of the UE.

The path reconstruction in FIG. 15 may refer to corresponding description above, the feature extraction may include a signature transform and a logarithmic transform as described above, and the feature selection may refer to the feature selection operation described above.

As an example, the determining of the information of the location of the UE by using the first AI model based on the first feature information includes: determining a communication environment between the UE and the base station based on the first feature information, and determining the information of the location of the UE based on the first feature information using the first AI model when the communication environment is a NLOS communication. As an example, when the communication environment is determined to be a LOS communication, the location of the UE may be determined based on a positioning method of the related art (i.e., a method not based on a machine learning model, the first method, such as a method based on a time difference of arriving, a method based on angle estimation, and the like).

As an example, the transmitting of the first feature information to the second node further includes: determining a communication environment between the UE and the base station based on the first feature information, and reporting information related to the determined communication environment to the second node.

As an example, the method shown in FIG. 4 may further include: receiving configuration information with including the environment information reporting request from the second node, when the configuration information indicates determining the location of the UE using a first method (e.g., an AI-based method), determining the location of the UE by using the first method based on the first feature information, and/or, when the configuration information indicates determining the location of the UE using, e.g., a second method, determine the location of the UE by using the second method.

As an example, the configuration information may be included in predefined downlink signal.

As an example, the base station or the LMF may determine a method used for positioning of the UE based on information received from the UE (e.g., information related to the communication environment, the first feature information, the second feature information), and configuration information for each method, and transmit the determined method and/or configuration information for the determined method to the UE which may determine the location of the UE based on the determined method and/or configuration information for the determined method and the feature information (e.g., the first feature information or the second feature information).

As an example, the determining of the information of the location of the UE by using the first AI model based on the first feature information includes: receiving configuration information for determining the location of the UE from a second node, when it is determined that the location of the UE is to be determined using the first AI model based on the configuration information for determining the location of the UE, determining the information of the location of the UE by using the first AI model based on the first feature information, wherein the first node is a UE and the second node is a base station or an LMF.

As an example, the determining of the information of the location of the UE based on the second feature information includes: determining the information of the location of the UE by using a third AI model based on the second feature information.

As an example, the determining of the information of the location of the UE by using the third AI model based on the second feature information includes: determining the information of the location of the UE by using the third AI model based on the second feature information, when the communication environment between the UE and the base station is a NLOS communication.

As an example, the method shown in FIG. 4 further includes: determining a communication environment between the UE and the base station based on the first feature information or the second feature information, the communication environment includes an LOS communication and an NLOS communication.

As an example, the determining of the communication environment between the UE and the base station based on the second feature information includes: determining the communication environment between the UE and the base station based on a LOS indicator or a NLOS indicator in the second feature information.

As an example, the base station or the LMF may determine a method for acquiring positioning-related operations and/or positioning information used by the UE based on a line-of-sight/non-line-of-sight indicator (LoS/NLOS indicator) and/or other measurement information. The UE may receive the indication or command of method for acquiring the positioning-related operations and/or the positioning information by means of an LTE positioning protocol (LPP) message and/or an radio resource control (RRC) configuration message and/or a media access control control element) and/or downlink control information (DCI) to. For example, when the indication or command is 0, the UE performs the acquisition of the positioning-related operation and/or positioning information using the first category methods and may obtain configuration information about the first category methods, for example, when the indication or command is 1, the UE performs the positioning-related operation and/or the acquisition of positioning information using the second category of methods and may obtain configuration information about the second category of methods.

For example, whether the communication environment between the UE and the plurality of base stations is a line-of-sight communication or a non-line-of-sight communication may be determined using a trained model based on the feature information (e.g., the first feature information or the second feature information).

For example, a non-machine learning model based scheme may be used to determine, based on the feature information (e.g., the first feature information or the second feature information), whether the communication environment between the UE and the multiple base stations is a line-of-sight communication or a non-line-of-sight communication.

As an example, the second feature information indicates at least one of a reference signal time difference (RSTD), a round trip delay (RTT), an angle of arrival (AOA), a reference signal receiving power (RSRP), a line-of-sight (LOS) indicator and a non-line-of-sight (NLOS) indicator.

As an example, the method shown in FIG. 4 may further include at least one of calculating a monitoring metric based on the first feature information and determining whether the AI model needs to be updated based on a result of comparing the monitoring metric with a predetermined threshold, transmitting the first feature information to a second node to cause the second node to calculate a monitoring metric criterion based on the first feature information and determine whether the AI model needs to be updated based on a result of comparing the monitoring metric with a predetermined threshold, and calculating a monitoring metric based on the first feature information, transmitting the monitoring metric to a second node to cause the second node to determine whether the AI model needs to be updated based on a result of comparing the monitoring metric with a predetermined threshold, wherein the first node is a UE and the second node is a base station or an LMF, or the first node is a base station and the second node is a UE or an LMF.

As an example, the calculating of the monitoring metric based on the first feature information includes calculating a paradigm of the first feature information and taking the paradigm as the monitoring metric.

As an example, the paradigm may be calculated based on 1 feature or a plurality of features in the feature information for each base station.

As an example, the number of paradigms may be calculated based on 1 feature or a plurality of features in the feature information for a plurality of base stations.

As an example, the model monitoring metric may be calculated based on results of one time of extraction of weighted time-energy feature information (i.e., the first feature information) or based on results of M times of extractions of weighted time-energy feature information, M being greater than or equal to one.

As an example, the paradigm calculated at one time or the average of the paradigms calculated at multiple times may be used as a model monitoring metric.

As an example, the paradigm of the first feature information may be obtained as follows:

$${‖ λ ‖}_{2} = \sqrt{{\sum }_{n = 1}^{N} {\vert {λ}_{l , n} \vert}^{2}}$$

wherein λ_{l,n} is the first feature of the first feature information of the nth base station.

As an example, the determining of whether the AI model needs to be updated (e.g., activated, de-activated, switched, or fallen back) based on the result of comparing the monitoring metric with the predetermined threshold may include: determining that the AI model needs to be updated when ∥λ∥₂>Th, wherein Th denotes the predefined threshold.

According to embodiments of the disclosure, since the features used to calculate the model monitoring metric reflect energy and time information of the channel, the obtained metric is a metric that may effectively differentiate between different operation scenarios, and thus based on the metric, it can better help to determine whether the AI model needs to be updated (e.g., model selection, activation/de-activation, switching, or fallback).

As an example, the first node is a UE, the method shown in FIG. 4 further includes: receiving from the second node configuration information indicating an update of the AI model, and updating the AI model based on the configuration information.

According to embodiments of the disclosure, good positioning performance may be achieved as the features inputted to the AI model incorporate energy and time information of the channel information. In addition, since the amount of data of the features inputted into the AI model is small, inference complexity (e.g., computational complexity and model complexity), measurement reporting signaling overhead, model transmission overhead, and model training time may be reduced.

As an example, the AI model described herein is trained by training the AI model with first labeled data, inputting unlabeled data into the AI model to obtain second labeled data corresponding to the unlabeled data, selecting the second labeled data based on a confidence level, and training the AI model that has been trained based on the first labeled data based on the first labeled data and the selected second labeled data.

As an example, the type of the machine learning model may be one of a type determined based on the AI method, and/or a type determined based on the number of floating point operations (FLOPs) of the neural network model, and/or a type determined based on latency requirement, and/or a type determined based on the size of the data needed/supported (the size of the data set and/or the size of the data dimension), and/or a type determined based on used arithmetic operations (e.g., convolution and/or matrix operations).

As an example, when the base station determines to instruct the UE is to locate using the method based on the machine learning model, hyper-parameter configuration information for the machine learning model and parameters related to a data set may be sent to the UE. For example, the hyper-parameter configuration information may include, for example, a learning rate and/or a number of layers and/or a batch size and/or an epoch times of the data set and/or a clipvalue. For example, the parameters related to the data set may include a data type of a set of data, and/or a number of parameters of corresponding data type (e.g., a set of data for positioning includes N channel impact response values, wherein the channel impact response value is a data type and N is the number of parameters of that data type), wherein N is obtained by receiving an instruction and/or is obtained by predetermining, and/or a number of sets of data.

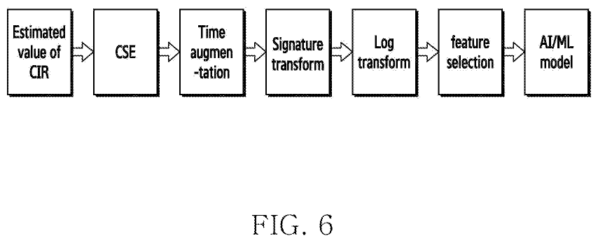

FIG. 6 illustrates a schematic diagram of a process for acquire a UE location based on a CIR estimated value according to an embodiment of the disclosure.

Referring to FIG. 6, a transform is first performed on the discrete estimated values of CIR based on a CSE scheme, and then a time and basepoint augmentation is performed on the transformed data, a signature transformation as well as a logarithmic transformation is performed on the time and basepoint-augmented data to obtain a number of features, and then a portion of the features is selected from the obtained features and inputted into the AI/ML model to determine the location of the UE.

Specific implementations of the individual steps illustrated in FIG. 6 may refer to corresponding descriptions above.

The dimension (18, 256, 2) of the estimated value of CIR is transformed to a dimension (18, 256, 1) by CSE-based transformation, to a dimension (18, 56, 2) by the time and basepoint augmentation, to a dimension (18, 30) by the logarithmic transformation, and to a dimension (18, 6) by the logarithmic transformation. If the estimated value of CIR is directly fed into a machine learning model to determine the location of the UE, it is clear that the model will be more complex and more difficult to be trained in order to ensure the accuracy of the model in determining the location.

It should be understood by those skilled in the art that examples of determining signature features are described above in terms of the estimated values of CIR, and when determining the location of the UE based on the machine learning model based on the estimated values of CFR, the concepts of path reconstruction, dimension expansion, and the time involved in the integral operation in the signature transformation should be replaced with frequency, e.g., by replacing the dimension expansion in the time domain with dimension expansion on the frequency domain, and integrating in the frequency domain with instead of integration over the time domain.

As an example, the method shown in FIG. 4 may further comprise: reporting first feature information to a base station or LMF based on the sixth rule and receiving configuration information based on the first feature information from said base station or LMF, and triggering an update of said AI model based on the configuration information based on the first feature information received from the base station or LMF.

As an example, the sixth rule is predetermined or determined based on the configuration information received from the base station or LMF.

As an example, the AI model is trained by training the AI model using the first labelled data, inputting unlabeled data into the AI model to obtain second labelled data corresponding to the unlabeled data, selecting the second labelled data based on a confidence level, and training the AI model that has been trained based on the first labelled data based on the first labelled data and the selected second labelled data.

As an example, a variance of the corresponding second labelled data may be obtained based on the obtained second labelled data, and based on a comparison between the variance and a predetermined threshold value, the obtained second labelled data within the threshold value is selected as the second labelled data with high confidence.

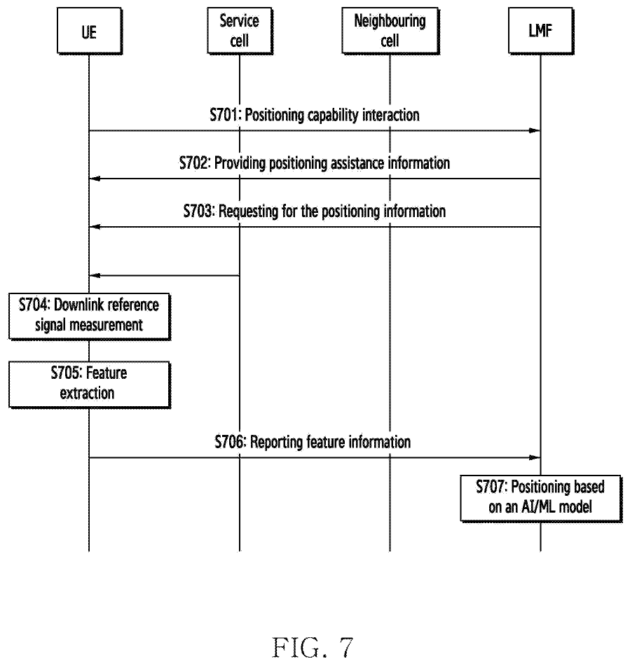

FIG. 7 illustrates a flowchart of a method in which a UE performs acquisition of first feature information and an LMF determining a location of the UE according to an embodiment of the disclosure.

Referring to FIG. 7, at operation S701, a positioning capability interaction is performed between the UE and the LMF.

As an example, the capability interaction between the UE and the LMF includes reporting of a capability supporting weighted time-energy feature extraction, reporting of a supported type of weighted time-energy feature, reporting of a supported number of weighted time-energy features, and reporting of a supported bit overhead for quantization of each feature, wherein the supported type of weighted time-energy feature may include 1^{st}-level statistical information of time and energy, 2^{nd}-level statistical information of time and energy and N^{th}-level statistical information of time and energy.

Referring to FIG. 7, at operation S702, the LMF provides positioning assistance information.

As an example, the positioning assistance information provided by the LMF includes configuration information of a downlink positioning reference signal (PRS), location information and or angle information of each base station, and measurement configuration information based on the positioning reference signal, and the like.

Referring to FIG. 7, at operation S703, the LMF requests the UE for the positioning information.

As an example, the LMF requesting the UE for the positioning information includes initiating, by the LMF, a request that indicates a type and a size of measurement that needs to be reported to the UE for obtaining the positioning information based on the artificial intelligence (AI) model used by the LMF, for example, the request indicates a need of reporting weighted time-energy feature information, a type of the feature information that is to be reported, and a number of bits that are to be reported. For example, a type that is be reported being N level weighted time-energy feature information may be represented in X bits, and a number of corresponding weighted time-energy feature information that needs to be reported may be represented in Y bits.

Referring to FIG. 7, at operation S704, a downlink reference signal measurement is performed to obtain information related to a channel.

Referring to FIG. 7, at operation S705, the UE obtains the first feature information based on the information related to the channel. The specific implementation may refer to the corresponding description above.

At operation S706, the UE may perform a quantization operation on the weighted time-energy feature information based on configured quantization bit information or quantization bits of a preset value, and feed the quantized first feature information to the LMF.

At operation S707, the LMF determines the location of the UE by using the AI model based on the first feature information.

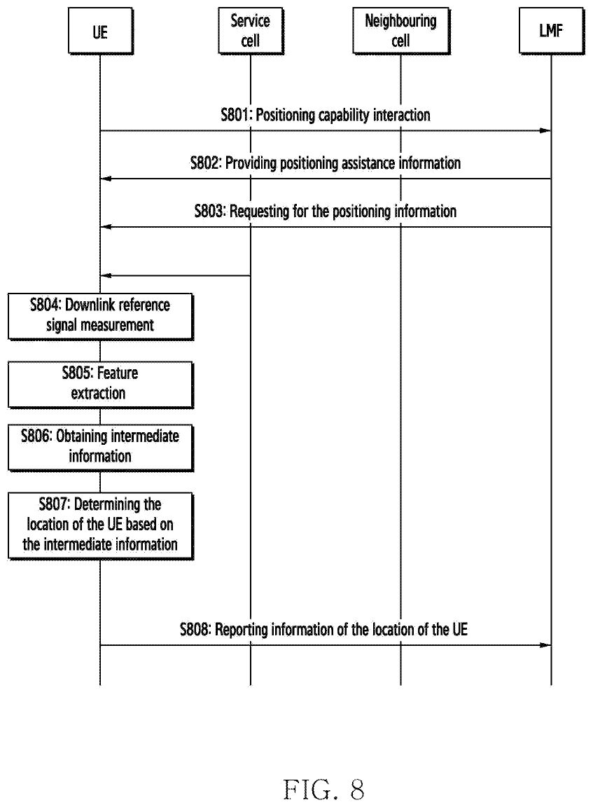

FIG. 8 illustrates a flowchart of a method in which a UE performs extracting of feature information and the UE determines a location of the UE according to an embodiment of the disclosure.

Referring to FIG. 8, at operation S801, a positioning capability interaction is performed between the UE and the LMF.

Alternatively, the capability interaction between the UE and the LMF includes reporting of capability supporting weighted time-energy feature extraction, reporting of a supported type of weighted time-energy features, wherein the supported type of time-energy feature may include: 1^{st}-level statistical information of time and energy, 2^{nd}-level statistical information of time and energy and Nth-level statistical information of time and energy.

Referring to FIG. 8, at operation S802, the LMF provides positioning assistance information.

The positioning assistance information provided by the LMF includes configuration information of a downlink positioning reference signal (PRS), position information and/or angle information of each base station, and measurement configuration information based on the positioning reference signal.

Referring to FIG. 8, at operation S803, the LMF requests the UE for measurements of the positioning information, and the step includes initiating, by the LMF, a request to the UE for obtaining the positioning information based on the method used to determine the location of the UE, the request including a type and time of measurements and reporting, such as time of arrival (TOA), time a difference of the reference signal (RSTD), an angle of arrival (AOA), an angle of departure (AOD), a line of sight communication (LOS) indicator, or a non-line of sight communication (NLOS) indicator.

Referring to FIG. 8, at operation S804, the UE obtains information about the channel between the UE and the plurality of base stations and the specific implementations may refer to corresponding description above.

Referring to FIG. 8, at operation S805, the UE obtains the first feature information and the specific implementations may refer to corresponding description above.

Referring to FIG. 8, at operation S806, the UE determines intermediate information or feature information related to the location of the UE based on the AI model and/or the configured type of measurement reporting based on the first feature information.

As an example, the intermediate information related to the location of UE may include time of arrival (TOA), a reference signal time difference (RSTD), an angle of arrival (AOA), an angle of departure (AOD), an LOS indicator or an NLOS indicator.

Referring to FIG. 8, at operation S807, the UE determines the location of the UE based on the extracted intermediate information related to the location of the UE.

As an example: if the time of arrival (TOA) is output as the intermediate information, the UE may determine the location of the UE based on the difference in arrival time of the positioning reference signal (PRS) from the base station to the UE, if the angle of arrival (AOA) is output as the intermediate information, the UE may determine the location of the UE based on the difference in angle of arrival of the positioning reference signal (PRS) from the base station to the UE, the determining of the location of the UE may be determining the location of the UE based on an AI model, or based on a method of the related art (i.e., a non-AI method), and for example, the method for determining the location of the UE used by the UE may be determined based on an LOS indicator or an NLOS indicator.

As an example, the UE may determine the location of the UE based on a method of the related art if communication is determined to be line-of-sight communication based on the line-of-sight indicator or the non-line-of-sight indicator. The UE may determine the location of the UE based on an AI model if the communication is determined to be non-line-of-sight communication based on the LOS indicator or the NLOS indicator.

Referring to FIG. 8, at operation S808, the UE provides information of the determined location of the UE to the LMF

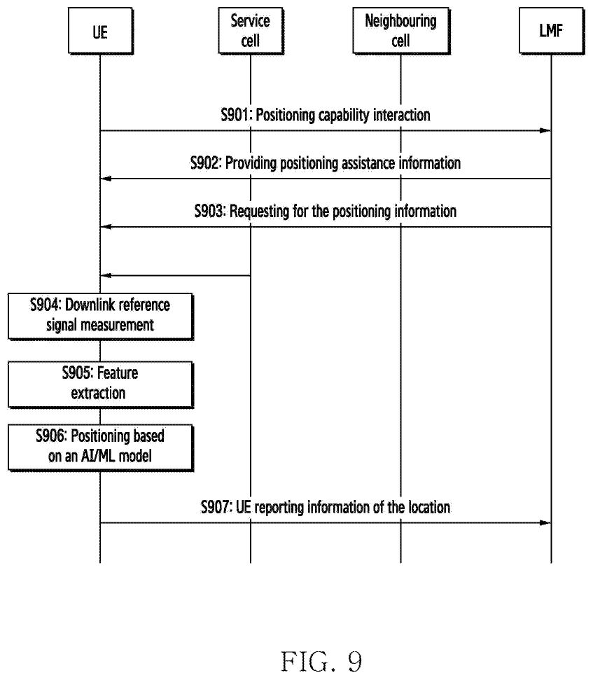

FIG. 9 illustrates a flowchart of a method in which a UE performs extracting of feature information and the UE determines a location of the UE according to an embodiment of the disclosure.

Referring to FIG. 9, at operation S901, a positioning capability interaction is performed between the UE and the LMF which may be referred to operation 701 of FIG. 7.

Referring to FIG. 9, at operation S902, the LMF provides positioning assistance information.

Referring to FIG. 9, at operation S903, the LMF requests the UE for positioning information.

Referring to FIG. 9, at operation S904, the UE obtains information about the channel between the UE and a plurality of base stations and the specific implementation may be referred to the corresponding description above.

Referring to FIG. 9, at operation S905, the UE obtains first feature information and the specific implementation may be referred to the corresponding description above.

Referring to FIG. 9, at operation S906, the UE determines the location of the UE using the AI model based on the first feature information.

Referring to FIG. 9, at operation S907, the UE may report information of the location of the UE to the LMF.

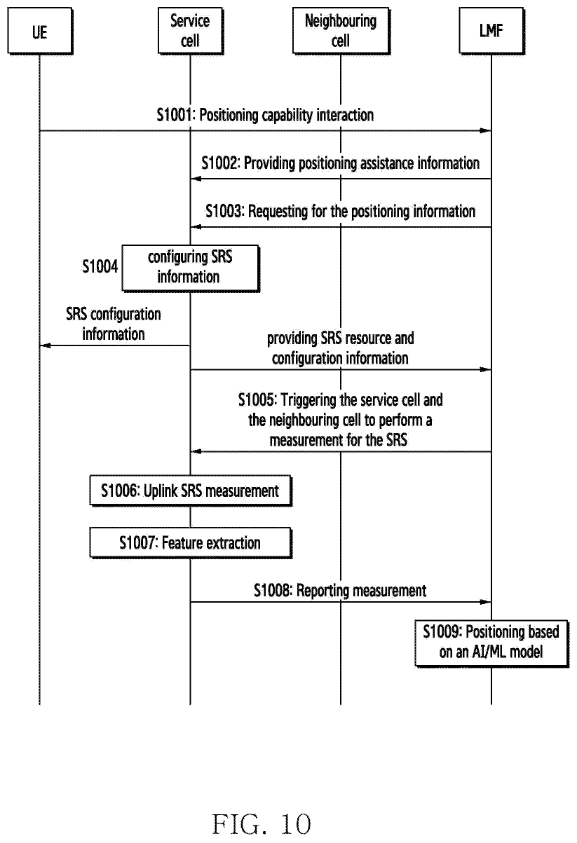

FIG. 10 illustrates a flowchart of a method in which a base station performs extracting of feature information and an LMF determines a location of a UE according to an embodiment of the disclosure.

Referring to FIG. 10, at operation S1001, a positioning capability interaction is performed between a service cell base station and the LMF and specific implementations thereof may refer to operation 701 of FIG. 7.

Referring to FIG. 10, at operation S1002, the LMF provides positioning assistance information.

As an example, the positioning assistance information provided by the LMF includes configuration information of the uplink reference signal (SRS), location information and/or angle information of each base station, and measurement configuration information based on a positioning reference signal.

Referring to FIG. 10, at operation S1003, the LMF requests for positioning information of the UE from the serving cell base station, and this step includes initiating, by the LMF, a request for positioning information acquisition from the serving cell base station based on a used artificial intelligence (AI) model to request the serving cell base station to provide configuration information of the SRS for positioning.

Referring to FIG. 10, at operation S1004, the serving cell base station determines SRS resources and configuration information, and configures corresponding SRS resource information for the UE via a high-level signaling RRC.

Referring to FIG. 10, at operation S1005, the LMF provides to the neighboring cell base station the SRS resource and configuration information for positioning, and triggers the base station to perform a measurement for the SRS.

As an example, the type of measurement and the type of reporting may include, supported extraction and reporting of weighted time-energy feature, reporting of a supported number of weighted time-energy features, and reporting of a supported bit overhead for quantization of each feature. For example, the type of measurement and the type of reporting indicate the weighted time-energy feature information to be reported, the type of feature information to be reported, and a number of bits to be reported. For example, the type to be reported being N level weighted time-energy feature information may be represented by X bits, and a number of corresponding weighted time-energy feature information that needs to be reported may be represented by Y bits.

Referring to FIG. 10, at operation S1006, the service cell base station obtains information about the channel between the UE and a plurality of base stations based on the configured SRS information and the specific implementation thereof may refer to foregoing description.

Referring to FIG. 10, at operation S1007, the first feature information is obtained and the implementation thereof may refer to corresponding description above.

Referring to FIG. 10, at operation S1008, the service cell base station reports the first feature information to the LMF.

As an example, the service cell base station may perform a quantization operation on the weighted time-energy feature information according to the configured quantization bit information or a preset value of quantization bits, and feed the quantized feature information to the LMF.

Referring to FIG. 10, at operation S1009, the LMF determines the location of the UE using an AI model based on the first feature information.

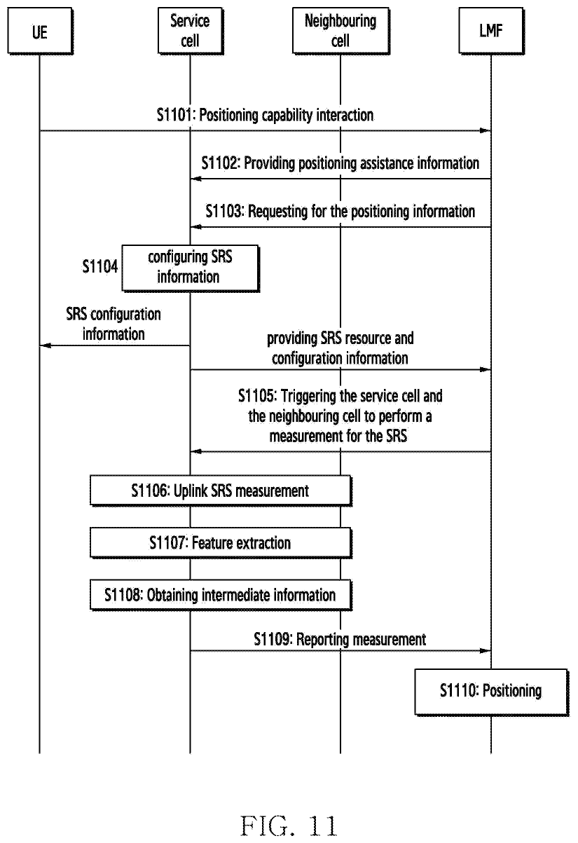

FIG. 11 illustrates a flowchart of a method in which a base station performs extracting of feature information and an LMF determines a location of a UE according to an embodiment of the disclosure.

Referring to FIG. 11, at operation S1101, a positioning capability interaction is performed between a service cell base station and the LMF and reference may be made to 701 of FIG. 7.

Referring to FIG. 11, at operation S1102, the LMF provides positioning assistance information.

As an example, the positioning assistance information provided by the information and or angle information of each base station, and measurement configuration information based on a positioning reference signal and the like.

Referring to FIG. 11, at operation S1103, the LMF requests for positioning information of the UE from the serving cell base station. The operation S1103 includes initiating, by the LMF, a request for positioning information acquisition from the serving cell base station based on the artificial intelligence AI model in use to requesting the serving cell base station to provide the configuration information of the SRS for positioning.

Referring to FIG. 11, at operation S1104, the serving cell base station determines SRS resources and configuration information, and configures corresponding SRS resource information for the UE via a high-level signaling RRC.

Referring to FIG. 11, at operation S1105, the LMF provides the SRS resource and configuration information for positioning to a neighboring cell base station and triggers the base station to perform a measurement for the SRS.

As an example, the type of measurement and the type of reporting include type and time that are measured and reported, such as TOA, RSTD, AOA, AOD, an LOS indicator or an NLOS indicator.

Referring to FIG. 11, at operation S1106, the serving cell base station obtains information about the channel between the UE and a plurality of base stations based on the configured SRS information and the specific implementation may refer to corresponding descriptions above.

Referring to FIG. 11, at operation S1107, the first feature information is obtained the specific implementation may refer to corresponding descriptions above.

Referring to FIG. 11, at operation S1108, the service cell base station determines intermediate information or feature information related to the location of the UE based on an AI model based on the extracted feature information.

Referring to FIG. 11, operation S1109, the serving cell base station reports to the LMF the intermediate information related to the location of the UE.

As an example, the service cell base station reports to the LMF the intermediate information related to the location of the UE based on the configured type of reporting.

Referring to FIG. 11, at operation S1110, the LMF determines the location of the UE based on the reported intermediate information related to the location of the UE and the method for determining the location of the UE.

As an example, if the TOA is reported, the LMF determines the location of the UE based on arrival time difference of the positioning reference signal SRS. If the AOA is reported, the LMF determines the location of the UE based on arrival angle difference of the positioning reference signal SRS. The determining of the location of the UE may be determining of the location of the UE based on an AI model or a method of the related art. For example, the method of determining the location of the UE used by the LMF is determined based on a reported LOS indicator or NLOS indicator.

As an example, if the communication environment between the base station and the UE is determined to be line-of-sight communication based on the LOS indicator or the NLOS indicator, the LMF may determine the location of the UE based on a traditional method, and if the communication environment between the base station and the UE is determined to be non-line-of-sight communication based on the LOS indicator or the NLOS indicator, the LMF may determine the location of the UE based on an AI model.

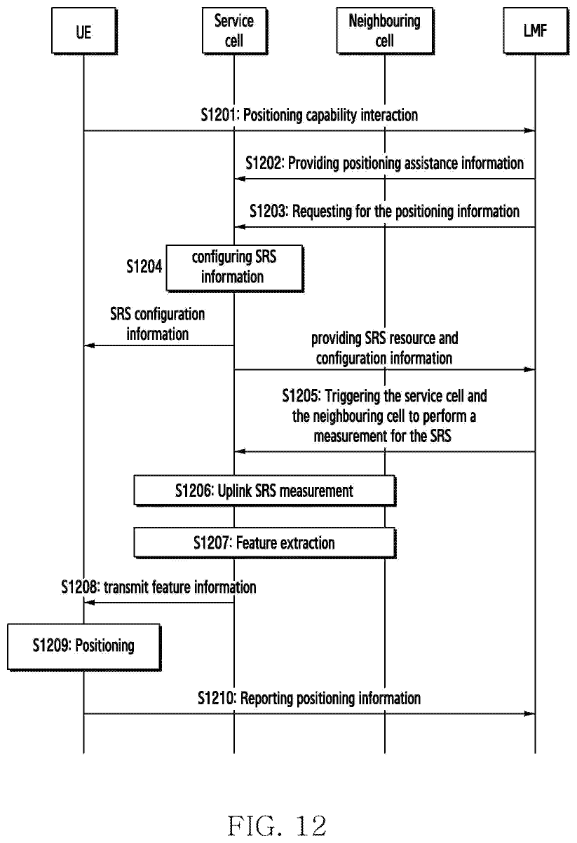

FIG. 12 illustrates a flowchart of a method in which a base station performs extracting of feature information and a UE determines a location of the UE according to an embodiment of the disclosure

Referring to FIG. 12, at operation S1201, a positioning capability interaction is performed between the UE and an LMF. Specific reference may be made to 701 of FIG. 7.

Referring to FIG. 12, at operation S1202, the LMF provides positioning assistance information.

As an example, the positioning assistance information provided by the information and or angle information of each base station, and measurement configuration information based on a positioning reference signal.

Referring to FIG. 12, at operation S1203, the LMF requests the serving cell base station for positioning information of the UE. The step S1203 includes that the LMF initiates a request for positioning information acquisition to the serving cell base station based on an AI model in use, to request the serving cell base station to provide the configuration information of the SRS for positioning.

Referring to FIG. 12, at operation S1204, the serving cell base station determines SRS resources and configuration information, and configures corresponding SRS resource information for the UE via a high-level signaling RRC.

Referring to FIG. 12, at operation S1205, the LMF provides SRS resource and configuration information for positioning to a neighboring cell base station, and triggers the base station to measure the SRS.

As an example, the LMF providing the SRS resource and configuration information for positioning to the neighboring cell base station and triggering the base station to perform a measurement on the SRS includes a type of measurement and a type of transmission, e.g., supported extraction and reporting of weighted time-energy features, reporting of a number of weighted time-energy features transmissions of which are supported, and a supported bit overhead for quantization of each feature. For example, the SRS resource and configuration information indicates the weighted time-energy feature information that need to be transmitted, the type of the feature information to be transmitted, and a number of bits to be transmitted. For example, the type to be transmitted being N level time-energy weighted feature information may be represented by X bits, and a number of corresponding time-energy-weighted feature information to be transmitted may be represented by Y bits.

Referring to FIG. 12, at operation S1206, the service cell base station obtains channel-related information based on the configured SRS information and the specific implementation thereof may refer to corresponding descriptions above.

Referring to FIG. 12, at operation S1207, the first feature information is obtained and the specific implementation thereof may refer to corresponding descriptions above.

Referring to FIG. 12, at operation S1208, the service cell base station transmits the first feature information to the UE.

As an example, the service cell base station performs a quantization operation on the time-energy weighted feature information based on the configured quantization bit information or a preset value of quantization bits based on the first feature information, and transmits the quantized first feature information to the UE.

Referring to FIG. 12, at operation S1209, the UE determines a location of the UE using an AI model based on the received first feature information.

Referring to FIG. 12, at operation S1210, the UE reports information of the location of the UE to the LMF.

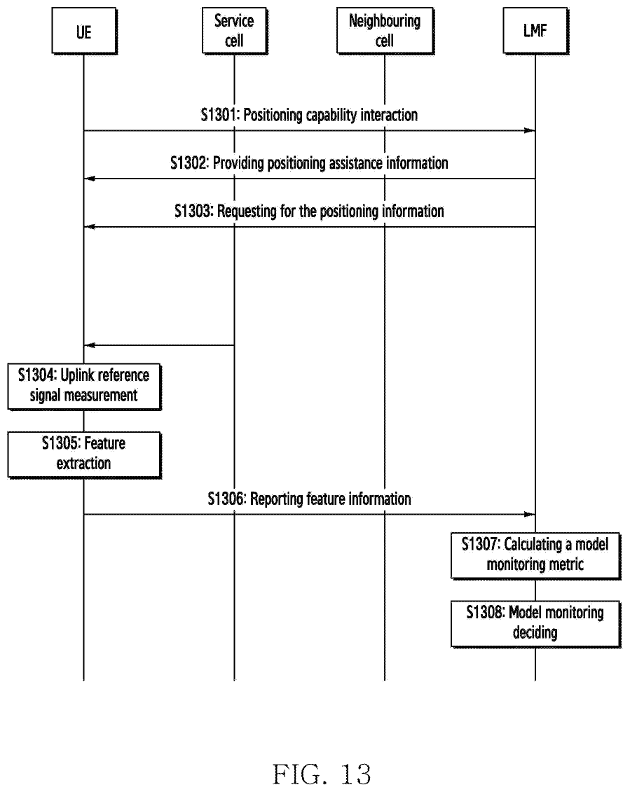

FIG. 13 illustrates a flowchart of a method in which a UE performs extracting of feature information and an LMF performs calculating of a model monitoring metric according to an embodiment of the disclosure.

Referring to FIG. 13, at operation S1301, a positioning capability interaction is performed between the UE and the LMF. Specific reference may be made to 701 of FIG. 7.

Referring to FIG. 13, at operation S1302, the LMF provides positioning assistance information.

As an example, the positioning assistance information provided by the LMF includes configuration information of a downlink positioning reference signal (PRS), position information and or angle information of each base station, and measurement configuration information based on a positioning reference signal and the like.

Referring to FIG. 13, at operation S1303, the LMF requests the UE for the positioning information.

As an example, the LMF requesting the UE for the positioning information includes that the LMF initiates a request to the UE for the positioning information based on an AI model in use, the request indicating types of measurement and reporting that are needed and a size for the reporting, e.g., time-energy weighted feature information that needs to be reported, the type of the feature information that needs to be reported, and a number of bits that needs to be reported. For example, the type to be reported being N level time-energy weighted feature information may be represented by X bits, and a number of corresponding time-energy-weighted feature information that needs to be reported may be represented by Y bits.

Referring to FIG. 13, at operation S1304, channel-related information is obtained.

Referring to FIG. 13, at operation S1305, the first feature information is obtained based on the channel-related information. The specific implementation may refer to corresponding description above.

Referring to FIG. 13, at operation S1306, the UE performs a quantization operation on the first feature information based on the configured quantization bit information or a preset value of quantization bits, and feeds the quantified first feature information to the LMF.

Referring to FIG. 13, at operation S1307, based on the first feature information, the LMF calculates a model monitoring metric.

Referring to FIG. 13, at operation S1308, the LMF performs a model monitoring decision.

As an example, the LMF determines whether the AI model needs to be activated, de-activated, switched or fallen back based on the reported model monitoring metric and a predefined threshold.

As an example, the monitoring metric may be calculated by the UE and sent to the LMF to determine by the LMF whether to update the AI model deployed at the UE or the LMF for determining the location of the UE based on a comparison of the monitoring metric with the predefined threshold.

As an example, the monitoring metric may be calculated by the UE and sent to the base station to determine, by the base station, whether to update the AI model deployed at the UE or the base station for determining the location of the UE based on feature information extracted from the information about the channel based on the comparison between the monitoring metric and the predetermined threshold.

As an example, feature information extracted from the information about the channel may be obtained by the base station, the feature information, the compressed feature information, or a portion of feature information selected from the compressed feature information may be sent to the LMF to be used by the LMF to compute the metric used for model monitoring and to perform update decision for the AI model deployed at the base station for determining the UE location based on the feature information extracted from the information about the channel.

As an example, the metric for model monitoring may be calculated by the base station and sent to the LMF to determine by the LMF whether or not to update the AI model deployed at the base station or the LMF for determining the location of the UE based on the feature information extracted from the information about the channel, based on a comparison of the metric with a predetermined threshold.

As an example, AI model that is monitoring monitored may be deployed at the base station, the UE, or the LMF for determining the location of the UE based on feature information extracted from the information about the channel, compressed feature information, or a portion of feature information selected from the compressed feature information.

A method for training the AI model used herein is described below.

It should be understood by those skilled in the art that the disclosure does not place any limitations on the selected AI/ML model with respect to the above feature information (e.g., the first feature information, the second feature information). It may be a multilayer perceptron (MLP), a convolutional neural network (CNN), a residual neural network (ResNet), or a kernel machine. In the case of an MLP, for example, a column vector 2 of logarithmic signature features selected from a plurality of base stations is fed into a first layer with an input and an output:

$${g}^{( 1 )} = f ( {w}^{( 1 )} λ + {b}^{( 1 )} ) ,$$

and an input and an output of a second layer are as follows:

$${g}^{( 2 )} = f ( {w}^{( 2 )} {g}^{( 1 )} + {b}^{( 2 )} )$$

wherein f(⋅) denotes an activation function, and w and b are model parameters.

For the MLP with L hidden layers, the input and output of the model (the output represents the information of the location of the UE) are as follows:

$$o = {w}^{( L + 1 )} {g}^{( L )} + {b}^{( L + 1 )} ,$$

wherein o∈ [symbol] ² when it is used for 2D positioning, o∈ [symbol] ³ when it is used for 3D positioning.

As an example, mean-squared error (MSE) based on a loss function may be used to train the model.

As an example, an apparatus may be identified as a training apparatus or a candidate training apparatus, if it satisfies one or more of the following conditions having known or partially known position information or having determined or partially determined position information, having a capability of performing a signature transform or a signature transform post-processing on measurement information, wherein the capability of performing the signature transform and/or the signature transform post-processing includes a path reconstruction of data and/or a time augmentation and signature transform processing and/or mean-variance normalization of the augmented data, the signature transform post-processing includes data feature degradation and/or data feature deletion, and the feature information includes multiple level signatures of the data, having a capability of reporting information features of the signature transformed information of the measurement information, wherein L signature features may be reported, for example, only one signature feature is reported when L=1, which may be the first level feature, the second level feature, or one feature of a plurality of levels of features, and when L=2, the method may report a plurality of signature features, which may be a combination of features of the first level feature and the second level feature, or may be a combination of multiple features of a plurality of levels of features.

As an example, the resource configuration information for training may include one or more of the following items the configuration information in relation to the first class methods described above, the positioning reference signal related configuration information for training (including an index configured for the positioning reference signal, a time-frequency resource location of the positioning reference signal, a period, or the like), an configuration related to an measurement gap (MG) and/or PRS processing window (PPW) for training, including a time length of the MG and/or PPW, a period size, a time start position, and the like. It should be understood by those skilled in the art that configuring the measurement interval and the like for training may better control the time at which the training data needs to be obtained, as the training data can only be obtained within a certain time range and can be valid for a certain period of time. For example, after exceeding a certain period of time, the training device moves elsewhere, and the previously given training data is no longer suitable, and thus only valid training data can help in obtaining a suitable and valid first class methods.

As an example, the operation of training the first class method based on the identified training apparatus and resources for training may include at least one of the following operations:
(1) the training apparatus obtains input information related to the first class method based on the obtained resources configuration information for training, wherein the input information may include channel impulse response information obtained by the training apparatus based on the reception of a positioning reference signal, and the information includes two types, one type of which is input information with corresponding position information, i.e., data with position labels, and another type of which is input information with only channel impulse response information (i.e., input information) and without corresponding position information, i.e., data without position labels;
(2) the training apparatus performs signature transform processing on the input information based on the obtained configuration information of the method for the data signature transform and the signature transformation post-processing, wherein, the training apparatus performs signature transform processing on the input information based on the obtained configuration information for the method for the data signature transform and the signature transform post-processing, performs the signature transform processing on the input information, and the training apparatus trains the first class method based on the obtained signature-transformed data with position labels and the position labels as an input;
(3) the training apparatus uses the obtained signature-transformed data without position labels as an input and generates location information estimation of the input information without corresponding position information (i.e., the position estimation of the input data without position labels), based on the first class method;
(4) the training apparatus selects, based on the confidence of the position estimation, the unlabeled data with a high degree of confidence and the generated position information estimation of the input information without corresponding position information, together with the data with position labels and the position labels as the input, and then re-trains the trained first class method;
(5) the training apparatus trains the first class method based on the output information obtained after the signature transform and/or the output information corresponding to the input information before the signature transform, and generates the position information estimation of the input information without corresponding position information, i.e., the position estimation of the input data without position labels;
(6) the training apparatus trains the first class method based on the position information estimation of the input information without corresponding information position and the determined position information and the input information before the signature transform (e.g., input information with and without position labels).

Alternatively, the training apparatus may feed the obtained input information related to the first class method to another training apparatus (e.g., a base station) and the model is trained by the other training apparatus. For example, the training apparatus UE feeds channel impulse response information obtained based on received positioning reference signal (i.e., the input information related to the first class method) and position information of the training apparatus at this time (including global position information and/or local position information, i.e., output information corresponding to the input information), as well as input information without position information, to a network-side apparatus to enable the base station (or the LMF in the base station) to train the model.

As an example, the AI model may be trained in the following manner: first determining a training dataset, e.g., the training dataset may include O sets of data, wherein each set of data includes feature information and position information of the UE corresponding to the feature information, then performing a mean-variance normalization operation on the O pieces of feature information to transform the O pieces of feature information to O pieces of feature information with mean-zero variance and unit variance, and taking the O pieces of transformed feature information and the position information of the UE corresponding to the O pieces of transformed feature information as training data to train the AI model.

Those skilled in the art should understand that the mean-variance normalization operation for transforming a set of data into data with zero mean-variance and unit-variance will not be repeated herein. As an example, the effectiveness of the trained machine learning model may be tested, and if the first class method used is confirmed to be effective, a valid first class method may be obtained, while if the first class method used is confirmed to be ineffective, an ineffective first class method may be obtained, and the model may then be retrained.

As an example, the testing process may include one or more of the following operations obtaining test data, wherein the test data is data used for testing the effectiveness of the used first class method and includes input information of the used first class method and/or output information corresponding to the input information, the input information of the used first class method and the output information corresponding to the input information may be information from a training apparatus and/or an apparatus specialized in providing test data, determining the validity of the first class method that has been tested, wherein the first class method that has been tested is determined to be valid if the first class method can successfully pass a test, for example, if test output information obtained based on the used first class method and the input information in the test data satisfies a certain condition, completing the testing process, wherein when it is determined that the first class method which has been tested is valid, and/or the first class method which has been tested satisfies the certain condition, the testing process may be considered to be successfully completed, and when it is determined that the first class method which has been tested is not valid, and/or the first class method which has been tested does not satisfy the certain condition, the testing process may be considered to be non-successfully completed.

As an example, the process of running (or inference) of a trained machine learning model (or a valid machine learning model) may include obtaining output information based on obtained input information according to obtained (or determined) configuration information of the machine learning model.

As an example, the process of running or inference may include at least one of the following operations determining a parameter configuration related to the first class method including parameter configuration information related to the first class method (including the same parameter configuration information as the parameter configuration information related to the class type of method presented in the training section), wherein the parameter configuration information may be obtained by an apparatus A by receiving configuration signaling sent by another apparatus, the apparatus A, for example, is a UE that determines the parameter configuration information needed for the first class method that are currently used by receiving the parameter configuration information of the first class method trained by the network-side apparatus, applying the determined parameter configuration information to configure the first class method, and alternatively, a lower layer (e.g., a physical layer) receiving the parameter configuration instructions from a higher layer to perform configuration for the first class method, obtaining input information related to the used first class method, wherein for example, the input information related to the first class method may be obtained by the apparatus itself or the input information related to the first class method may be obtained by receiving feedback from another apparatus, and the input information includes parameters related to dataset in the configuration information related to the first class method in the training section above.

As an example, a model library of the first class method may also be established based on the correspondence between a signature feature and a model, and the establishing may specifically include the following processes: scene construction, in which the scene is modelled, the base coordinates are established according to demanded accuracy, and corresponding base coordinates are outputted, model library construction in which all the test data is collected, a signature transform is performed on all the test data, and a signature feature database is generated, model training in which a model library of the trained first class method for positioning-related operations and/or positioning information acquisition operations is obtained based on the tested data, a matching relationship between the model library and the signature features of information is established, the matching relationship between the model library and the signature feature of information may be a one-to-one mapping or a many-to-one mapping relationship. For example, one signature feature of information corresponds to one model, or a plurality of signature features may correspond to one model.

As an example, when using the first class method, the configuration information of the used first class method may change, e.g., due to a change in the environment (e.g., a change in the channel conditions, or the like), and it is necessary to correct and/or switch the configuration information and/or model of the used first class method, so that it is possible to correct or switch the model of the first class method with a less effort and/or in a shorter time to re-operate.

As an example, the UE may report that it has a capability of performing positioning-related operations and a positioning information acquisition method based on preprocessing of the signature transform, and may obtain relevant configuration information for performing the signature feature reporting by receiving a high-level message (RRC) and/or a MAC CE and/or DCI, and the configuration information may include: a period for reporting the signature feature, a method of reporting, and an level and a number of signature features to be reported. The UE may obtain relevant input information by receiving and/or measuring positioning-related operations and positioning information, obtain relevant configuration information for performing the signature feature reporting based on the received high-level information (RRC) and/or the MAC CE and or the DCI, perform a pre-processing operation of the signature transform on the input, and report the corresponding signature feature information, the base station may perform, based on the reported signature feature information, feature matching for the model that selects a model corresponding to the signature feature of information with the highest matching degree to be used for model supervision or updating.

For example, based on the reported signature features of information and or historical positioning information of the UE, the signature features of information corresponding to N points in the surrounding neighborhood may be selected for similarity calculation. The matching for the similarity may be described using the Euclidean distance, wherein a smaller Euclidean distance indicates a higher similarity, and based on the output for the similarity, the model corresponding to the corresponding channel signature feature is selected and updating is performed.

As an example, the UE may obtain, via the received MAC CE and/or DCI, configuration information for the update of the model to performing positioning-related operations.

As an example, the UE may report the feature information to the base station in accordance with a preset rule and receive configuration information based on the feature information from the base station, update the machine learning model based on the configuration information received from the base station.

As an example, the UE may report the feature information (e.g., a first-order feature or a multi-order feature) to the base station at predetermined intervals or when a number of localizations reach a predetermined value.

As an example, the UE may report feature information obtained for a plurality of times of together to the base station. For example, the UE may report feature information recently acquired for a predetermined number of times to the base station after acquiring the feature information for a predetermined number of times.

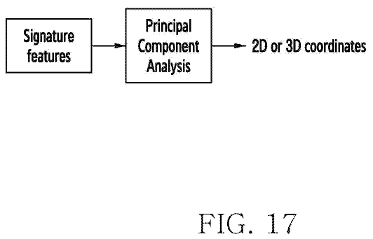

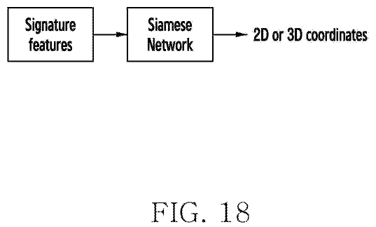

FIGS. 17 and 18 illustrate schematic diagrams of downscaling using principal component analysis and the Siamese network according to various embodiments of the disclosure.

Referring to FIGS. 17 and 18, as an example, further dimensionality reduction may be performed based on the signature of information and or historical positioning information reported by the UE, and the dimensionality is downscaled to 2D or 3D for similarity calculation in the 2D or 3D coordinates. The dimensionality reduction method includes, but are not limited to principal component analysis (PCA), Isomap mapping (Isomap), t-distributed stochastic neighborhood embedding (t-SNE), Laplacian eigenmaps, Siamese network, triplet network, and the like. In the downscaled 2D or 3D coordinates, points among which Euclidean distances are small indicate that distances among them in the real physical coordinates are also small. FIGS. 17 and 18 show the schematic diagrams of downscaling using the principal component analysis and the Siamese Network.

As an example, when the reported signature of information is downscaled to 2D or 3D coordinates using the Siamese network, a certain feature, such as

$${λ}_{1 , 2 , 2} = \frac{1}{12} {\sum }_{n = 1}^{N} {p}_{n} ( {t}_{N}^{2} + 2 {t}_{n}^{2} + 2 {t}_{n - 1}^{2} + 2 {t}_{n} {t}_{n - 1} - 3 {t}_{N} ( {t}_{n} + {t}_{n - 1} ) ) ,$$

is selected as a distance metric criterion when the Siamese Network is trained, as the loss function used for training the Siamese Network is as follows:

$$L ( {c}_{I} , {c}_{j} ) = \sqrt{{\sum }_{( i , j ) ∈ {P}_{batch}} {( d ( {Λ}_{i} , {Λ}_{j} ) - {‖ {c}_{i} - {c}_{j} ‖}_{2} )}^{2}}$$

wherein c_{I}, cⱼ denote the 2D or 3D coordinates of the downscaled samples I, j, P_{batch} denotes a set of index pairs for a batch of samples, Λ_{I}, Λⱼ denote information signatures of the samples i, j and d(Λ_{I}, Λⱼ) denotes a distance between information signatures, which may be defined as:

$$d ( {Λ}_{I} , {Λ}_{j} ) {=}^{△} {‖ {s}_{i} - {s}_{j} ‖}_{1}$$

wherein s_{I}, sⱼ denote a certain signature feature of samples I, j. As an example, sᵢ=[λ_{1,2,2}^{(i,1)}, λ_{1,2,2}^{(i,2)}, . . . , λ_{1,2,2}^{(i,j)}, I, λ_{1,2,2}^{(i,N}^{_{b}}⁾], wherein λ_{1,2,2}^{(i,j)} denotes a signature feature λ_{1,2,2} for the jth base station or antenna from the sample i.

In embodiments of the disclosure, there is also provided an electronic apparatus that includes at least one processor, and alternatively, further includes at least one transceiver and/or at least one memory coupled to the at least one processor, wherein, the at least one processor is configured to perform the steps of the method provided in any alternative embodiment of the disclosure.

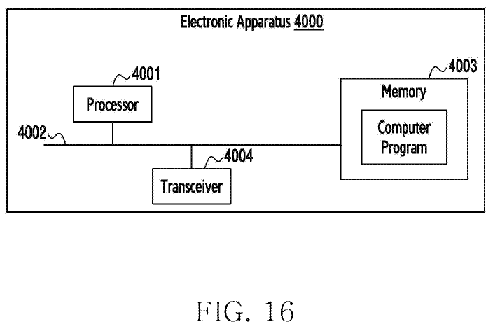

FIG. 16 illustrates a schematic diagram of a structure of an electronic apparatus applicable to according to an embodiment of the disclosure.

Referring to FIG. 16, an electronic apparatus 4000 shown in FIG. 16 includes a processor 4001 and memory 4003. Wherein the processor 4001 and the memory 4003 are coupled, e.g., through a bus 4002. Alternatively, the electronic apparatus 4000 may further include a transceiver 4004 which may be used for data interaction between the electronic apparatus and other electronic apparatuses, such as transmitting of data and/or receiving of data. It should be noted that, each of the processor 4001, the memory 4003, and the transceiver 4004 is not limited to one in a practice application, and the structure of the electronic apparatus 4000 does not constitute a limitation of the embodiments of the disclosure. Alternatively, the electronic apparatus may be the first network node, the second network node, or the third network node. Alternatively, the electronic apparatus may be the first node or the second node described above.

The processor 4001 may be a central processing unit (CPU), general purpose processor, digital signal processor (DSP), application specific integrated circuit (ASIC), field programmable gate array (FPGA) or other programmable logic device, transistor logic device, hardware part, or any combination thereof. The processor 4001 may implement or perform various logic boxes, modules, and circuits described in conjunction with the disclosed contents of the disclosure. The processor 4001 may also be a combination that implements computing functions, such as a combination containing one or more microprocessors, a combination of a DSP and a microprocessor, and the like.

The bus 4002 may include a pathway to transfer information between the above components. The bus 4002 may be a peripheral component interconnect (PCI) bus or an extended industry standard architecture (EISA) bus, and the like. The bus 4002 may be classed as an address bus, a data bus, a control bus, and the like. For ease of representation, only one bold line is shown in FIG. 16, but it does not mean that there is only one bus or one type of bus.

The memory 4003 may be read only memory (ROM) or other types of static storage apparatuses that can store static information and instructions, random access memory (RAM) or other types of dynamic storage apparatuses that can store information and instructions, may be electrically erasable programmable read only memory (EEPROM), compact disc read only memory (CD-ROM) or other optical disc storages, an optical disc storage (including a compressed disc, laser disc, optical disc, digital universal disc, Blu-ray disc, or the like), a disk storage medium, other magnetic storage apparatuses, or any other medium that can be used to carry or store computer programs and can be read by a computer, it is not limited herein.

The memory 4003 is used to store computer programs or executable instructions for performing the embodiments of the disclosure, and is controlled for execution by the processor 4001. The processor 4001 is used to execute the computer programs or executable instructions stored in the memory 4003 to implement the steps shown in the preceding method of the embodiments.

A method performed by a first node in a wireless communication system, comprises obtaining information related to a channel between a user equipment (UE) and a base station. The method comprises extracting first feature information based on the information related to the channel between the UE and the base station, the first feature information being used to determine information of a location of the UE using an artificial intelligence (AI) model and/or to monitor whether the AI model needs to be updated.

For example, the first feature information is related to energy and/or time of arrival of a multipath of the channel between the UE and the base station.

For example, the first feature information comprises at least one of feature information obtained by weighting the time of arrival of the multipath of the channel between the UE and the base station based on the energy of the channel between the UE and the base station and feature information obtained by weighting the energy of the channel between the UE and the base station based on the time of arrival of the multipath of the channel between the UE and the base station.

For example, the extracting of the first feature information based on the information related to the channel between the UE and the base station comprises extracting the first feature information by using a signature transform based on the information related to the channel.

For example, the extracting of the first feature information comprises determining multi-dimensional continuous values corresponding to the information related to the channel and extracting the first feature information based on the multi-dimensional continuous values.

For example, the determining of the multi-dimensional continuous values corresponding to the information related to the channel comprises transforming the information related to the channel into one-dimensional continuous values and expanding the one-dimensional continuous values into the multi-dimensional continuous values.

For example, the expanding of the one-dimensional continuous values into the multi-dimensional continuous values comprises performing data augmentation on the one-dimensional continuous values corresponding to the information related to the channel over a predetermined domain to expand the one-dimensional continuous values into the multi-dimensional continuous values.

For example, the performing of data augmentation on the one-dimensional continuous values corresponding to the information related to the channel over the predetermined domain comprises performing the data augmentation on the one-dimensional continuous values corresponding to the information related to channel over d1-1 predetermined domains to expand the one-dimensional continuous values into d1-dimensional values, wherein d1 is greater than or equal to 2.

For example, the predetermined domain comprises a time domain when the information related to the channel indicates an estimate value of channel impulse response (CIR). The predetermined domain comprises a frequency domain when the information related to the channel indicates an estimated value of channel frequency response (CFR).

For example, when the information related to the channel indicates an estimated value of CIR, the information related to the channel comprises N estimated values of CIR about the channel between the UE and the base station for N moments. The transforming of the information related to the channel between the UE and the base station into the one-dimensional continuous values comprises transforming the N estimated values of CIR corresponding to the base station into N values corresponding to the N moments, and obtaining values corresponding to any moment between a first moment and an Nth moment based on the N values to obtain the one-dimensional continuous values from the first moment to the Nth moment.

A method performed by a second node in a wireless communication system, comprises receiving first feature information or second feature information transmitted by a first node. The method comprises when the first feature information is received, performing at least one of determining information of a location of a user device (UE) using a first artificial intelligence (AI) model based on the first feature information, or determining second feature information using a second AI model based on the first feature information and determining the information of the location of the UE based on the second feature information. The method comprises when the second feature information is received, determining the information of the location of the UE based on the received second feature information. The received first feature information is extracted based on information related to a channel between the UE and a base station by the first node, and/or the received second feature information is determined based on the extracted first feature information using a second AI model by the first node.

A method performed by a second node in a wireless communication system, comprises receiving first feature information or a monitoring metric transmitted by a first node. The method comprises, when the first feature information is received, calculating a monitoring metric based on the first feature information, and determining whether an artificial intelligence (AI) model corresponding to determining a location of a user device (UE) needs to be updated based on a result of comparing the monitoring metric with a predetermined threshold. The method comprises, when the monitoring metric is received, determining whether the AI model needs to be updated based on a result of comparing the monitoring metric and the predetermined threshold value. The received first feature information is extracted based on information related to a channel between the UE and a base station by the first node, and/or the received monitoring metric is calculated based on the extracted first feature information by the first node.

A node in a wireless communication system, comprises memory storing one or more computer programs and one or more processors communicatively coupled to the memory. The one or more computer programs include computer-executable instructions that, when executed by the one or more processors, cause the node to obtain information related to a channel between a user equipment (UE) and a base station. The one or more computer programs include the computer-executable instructions that, when executed by the one or more processors, cause the node to extract first feature information based on the information related to the channel between the UE and the base station, the first feature information being used to determine information of a location of the UE using an artificial intelligence (AI) model and/or to monitor whether the AI model needs to be updated.

For example, the first feature information is related to energy and/or time of arrival of a multipath of the channel between the UE and the base station.

For example, the first feature information comprises at least one of feature information obtained by weighting the time of arrival of the multipath of the channel between the UE and the base station based on the energy of the channel between the UE and the base station and feature information obtained by weighting the energy of the channel between the UE and the base station based on the time of arrival of the multipath of the channel between the UE and the base station.

For example, The one or more computer programs include the computer-executable instructions that, when executed by the one or more processors, cause the node to extract the first feature information by using a signature transform based on the information related to the channel.

For example, the one or more computer programs include the computer-executable instructions that, when executed by the one or more processors, cause the node to determine multi-dimensional continuous values corresponding to the information related to the channel. The one or more computer programs include the computer-executable instructions that, when executed by the one or more processors, cause the node to extract the first feature information based on the multi-dimensional continuous values.

For example, the one or more computer programs include the computer-executable instructions that, when executed by the one or more processors, cause the node to transform the information related to the channel into one-dimensional continuous values. The one or more computer programs include the computer-executable instructions that, when executed by the one or more processors, cause the node to expand the one-dimensional continuous values into the multi-dimensional continuous values.

One or more non-transitory computer readable storage media storing computer-executable instructions that, when executed by one or more processors of a node in a wireless communication system, cause the node to perform operations. The operations comprise obtaining information related to a channel between a user equipment (UE) and a base station. The operations comprise extracting first feature information based on the information related to the channel between the UE and the base station, the first feature information being used to determine information of a location of the UE using an artificial intelligence (AI) model and/or to monitor whether the AI model needs to be updated.

For example, the first feature information is related to energy and/or time of arrival of a multipath of the channel between the UE and the base station.

A method performed by a first node in a wireless communication system, comprises obtaining information related to a channel between a user equipment (UE) and a base station. The method comprises extracting first feature information based on the information related to the channel between the UE and the base station, the first feature information being used to determine information of a location of the UE using an artificial intelligence (AI) model.

A node in a wireless communication system, comprises memory storing one or more computer programs and one or more processors communicatively coupled to the memory. The one or more computer programs include computer-executable instructions that, when executed by the one or more processors, cause the node to obtain information related to a channel between a user equipment (UE) and a base station. The one or more computer programs include the computer-executable instructions that, when executed by the one or more processors, cause the node to extract first feature information based on the information related to the channel between the UE and the base station, the first feature information being used to determine information of a location of the UE using an artificial intelligence (AI) model.

One or more non-transitory computer readable storage media storing computer-executable instructions that, when executed by one or more processors of a node in a wireless communication system, cause the node to perform operations. The operations comprise obtaining information related to a channel between a user equipment (UE) and a base station. The operations comprise extracting first feature information based on the information related to the channel between the UE and the base station, the first feature information being used to determine information of a location of the UE using an artificial intelligence (AI) model.

An embodiment of the disclosure provides a computer readable storage medium storing computer programs or instructions, the computer programs or instructions, when being executed by at least one processor may perform or implement the steps in the preceding method of the embodiments and corresponding contents.

An embodiment of the disclosure provides a computer program product including computer programs, the computer programs, when being executed by a processor, may implement the steps shown in the preceding method of the embodiments and corresponding contents.

The terms “first”, “second”, “third”, “fourth”, “1”, “2” and the like (if exists) in the specification and claims of the disclosure and the above drawings are used to distinguish similar objects, and need not be used to describe a specific order or sequence. It should be understood that, data used as such may be interchanged in appropriate situations, so that the embodiments of the disclosure described here may be implemented in an order other than the illustration or text description.

It should be understood that, although each operation step is indicated by an arrow in the flowcharts of the embodiments of the disclosure, an implementation order of these steps is not limited to an order indicated by the arrows. Unless explicitly stated herein, in some implementation scenarios of the embodiments of the disclosure, the implementation steps in the flowcharts may be executed in other orders according to requirements. In addition, some or all of the steps in each flowchart may include a plurality of sub steps or stages, based on an actual implementation scenario. Some or all of these sub steps or stages may be executed at the same time, and each sub step or stage in these sub steps or stages may also be executed at different times. In scenarios with different execution times, an execution order of these sub steps or stages may be flexibly configured according to a requirement, which is not limited by the embodiment of the disclosure.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first node in a wireless communication system, the method comprising:
obtaining information related to a channel between a user equipment (UE) and a base station; and
extracting first feature information based on the information related to the channel between the UE and the base station, the first feature information being used to determine information of a location of the UE using an artificial intelligence (AI) model.

2. The method of claim 1, wherein the first feature information is related to energy and/or time of arrival of a multipath of the channel between the UE and the base station.

3. The method of claim 2, wherein the first feature information comprises at least one of feature information obtained by weighting the time of arrival of the multipath of the channel between the UE and the base station based on the energy of the channel between the UE and the base station and feature information obtained by weighting the energy of the channel between the UE and the base station based on the time of arrival of the multipath of the channel between the UE and the base station.

4. The method of claim 1, wherein the extracting of the first feature information based on the information related to the channel between the UE and the base station comprises:
extracting the first feature information by using a signature transform based on the information related to the channel.

5. The method of claim 1, wherein the extracting of the first feature information comprises:
determining multi-dimensional continuous values corresponding to the information related to the channel; and
extracting the first feature information based on the multi-dimensional continuous values.

6. The method of claim 5, wherein the determining of the multi-dimensional continuous values corresponding to the information related to the channel comprises:
transforming the information related to the channel into one-dimensional continuous values; and
expanding the one-dimensional continuous values into the multi-dimensional continuous values.

7. The method of claim 6, wherein the expanding of the one-dimensional continuous values into the multi-dimensional continuous values comprises:
performing data augmentation on the one-dimensional continuous values corresponding to the information related to the channel over a predetermined domain to expand the one-dimensional continuous values into the multi-dimensional continuous values.

8. The method of claim 7, wherein the performing of data augmentation on the one-dimensional continuous values corresponding to the information related to the channel over the predetermined domain comprises:
performing the data augmentation on the one-dimensional continuous values corresponding to the information related to channel over d1-1 predetermined domains to expand the one-dimensional continuous values into d1-dimensional values, wherein d1 is greater than or equal to 2.

9. The method of claim 8,
wherein the predetermined domain comprises a time domain when the information related to the channel indicates an estimate value of channel impulse response (CIR), and/or
wherein the predetermined domain comprises a frequency domain when the information related to the channel indicates an estimated value of channel frequency response (CFR).

10. The method of claim 6, wherein, when the information related to the channel indicates an estimated value of CIR, the information related to the channel comprises:
N estimated values of CIR about the channel between the UE and the base station for N moments; and
the transforming of the information related to the channel between the UE and the base station into the one-dimensional continuous values comprises:
transforming the N estimated values of CIR corresponding to the base station into N values corresponding to the N moments, and obtaining values corresponding to any moment between a first moment and an Nth moment based on the N values to obtain the one-dimensional continuous values from the first moment to the Nth moment.

11. A method performed by a second node in a wireless communication system, the method comprising:
receiving first feature information or second feature information transmitted by a first node;
when the first feature information is received, performing at least one of determining information of a location of a user device (UE) using a first artificial intelligence (AI) model based on the first feature information, or determining second feature information using a second AI model based on the first feature information and determining the information of the location of the UE based on the second feature information; and
when the second feature information is received, determining the information of the location of the UE based on the received second feature information,
wherein the received first feature information is extracted based on information related to a channel between the UE and a base station by the first node, and/or the received second feature information is determined based on the extracted first feature information using a second AI model by the first node.

12. A node in a wireless communication system, the node comprising:
memory storing one or more computer programs; and
one or more processors communicatively coupled to the memory,
wherein the one or more computer programs include computer-executable instructions that, when executed by the one or more processors, cause the node to:
obtain information related to a channel between a user equipment (UE) and a base station, and
extract first feature information based on the information related to the channel between the UE and the base station, the first feature information being used to determine information of a location of the UE using an artificial intelligence (AI) model.

13. The node of claim 12, wherein the first feature information is related to energy and/or time of arrival of a multipath of the channel between the UE and the base station.

14. The node of claim 13, wherein the first feature information comprises at least one of feature information obtained by weighting the time of arrival of the multipath of the channel between the UE and the base station based on the energy of the channel between the UE and the base station and feature information obtained by weighting the energy of the channel between the UE and the base station based on the time of arrival of the multipath of the channel between the UE and the base station.

15. The node of claim 12, wherein the one or more computer programs further include computer-executable instructions that, when executed by the one or more processors, cause the node to:
extract the first feature information by using a signature transform based on the information related to the channel.

16. The node of claim 12, wherein the one or more computer programs further include computer-executable instructions that, when executed by the one or more processors, cause the node to:
determine multi-dimensional continuous values corresponding to the information related to the channel, and
extract the first feature information based on the multi-dimensional continuous values.

17. The node of claim 16, wherein the one or more computer programs further include computer-executable instructions that, when executed by the one or more processors, cause the node to:
transform the information related to the channel into one-dimensional continuous values, and
expand the one-dimensional continuous values into the multi-dimensional continuous values.

18. One or more non-transitory computer readable storage media storing computer-executable instructions that, when executed by one or more processors of a node in a wireless communication system, cause the node to perform operations, the operations comprising:
obtaining information related to a channel between a user equipment (UE) and a base station; and
extracting first feature information based on the information related to the channel between the UE and the base station, the first feature information being used to determine information of a location of the UE using an artificial intelligence (AI) model.

19. The one or more non-transitory computer-readable storage media of claim 18, wherein the first feature information is related to energy and/or time of arrival of a multipath of the channel between the UE and the base station.

20. The one or more non-transitory computer-readable storage media of claim 18, wherein the first feature information comprises at least one of feature information obtained by weighting the time of arrival of the multipath of the channel between the UE and the base station based on the energy of the channel between the UE and the base station and feature information obtained by weighting the energy of the channel between the UE and the base station based on the time of arrival of the multipath of the channel between the UE and the base station.
